(19) United States
(12) Patent Application Publication
(10) Pub. No.: US 2003/0114313 A1
(43) Pub. Date: Jun. 19, 2003

(54) Technical and theoretical specifications for warp drive technology

(76) Inventors: Andrew Peter Worsley, Kent (GB); Peter John Twist, Tortola (GB)

Correspondence Address: LARSON & TAYLOR, PLC, 1199 NORTH FAIRFAX STREET, SUITE 900, ALEXANDRIA, VA, 22314, US

(21) Appl. No.: 10/182,373

(22) PCT Filed: Jan. 30, 2001
(86) PCT No.: PCT/GB01/00381

(30) Foreign Application Priority Data
Jan. 31, 2000 (GB) 0002221.0
Nov. 24, 2000 (GB) 0028721.9

(51) Int. Cl. H01S 1/00

(52) U.S. Cl. 505/180

(57) ABSTRACT

The present invention relates to the use of technical drive systems, which operate by the modification of gravitational fields. These drive systems do not depend on the emission of matter to create thrust but create a change in the curvature of space-time, in accordance with general relativity. This allows travel by warping space-time to produce an independent warp drive system. Differentials electron flow through a body in rotation is directed so as to simultaneously pass through a said body In its direction of

### FIELD OF THE INVENTION

The present invention relates to the use of technical drive systems which operate by the modification of gravitational fields. These drive systems do not depend on the emission of matter to create thrust, but create a change in the curvature of space-time, in accordance with general relativity. This allows travel by warping space-time, to produce an independent warp drive system.

### THEORETICAL BACKGROUND OF THE INVENTION

The concept of gravity should be examined in the light of quantum gravity and in turn as a component of quantum physics itself. The fundamental minimal quantum of energy in quantum physics is Planck's constant; h. Thus in accordance with the energy equivalence formula E=mc², the fundamental minimum quantity of mass (m_{q}) can therefore be derived, from known constants by; m_{q}=h/c² (1). Taking this minimal mass, it is possible to show that the formation of all matter, the forces of nature and indeed space-time itself derive from this single quintessential quantity.

Thus if the number of quintessences in a system is; n_{q}=m/m_{q}: then the total Energy of the system is more logically given by, the energy of a single quintessence (h); directly multiplied by the number of quintessences (n_{q}) in that system, thus E=hn_{q}=mc² (1 a).

Furthermore, this minimal mass, termed quintessence, can form the basis of the existence of a quantum gravitational field in the form of a space-time lattice, from which quantum gravity may be derived from first principles. Furthermore, the conglomeration of these quintessences also accounts for the formation of the elementary particles and the forces acting between them, as in superstring theory. This concept explains the formation of matter and the forces of nature on a quantum mechanical basis and directly explains the existence of wave particle duality. Thus as n_{q}=m/m_{q}; the frequency of light and matter (f) is determined, directly, from the number of constituent quintessences. This leads automatically to the fundamental equation, derived from (1), f=n_{q}=E/h, where n_{q} is the number of quintessences, which leads directly to the frequency of both light and matter. This in turn leads directly to a Universal wave equation for matter and light λ=c/βn_{q}=hc/βE (2), where β is the relative directional velocity, v/c. As the momentum, p=βE/c, then this equation also gives the standard de-Broglie wave equation, λ=h/p in agreement with current theory and experiments.¹

Using the Universal wave equation, the standard equation for special relativity, m′=mₒ/(1−β²)^{1/2}, derives from first principles. Also from these observations, a modified Dirac wave equation may be derived, Eψ=(−jβ·∇+βm)ψ (2a), the results of which have been recently verified by a paper in which the orbitals of electrons were experimentally directly visualised.² Moreover, a fundamental equation for general relativity can be formulated, where G is the gravitational constant and r_{q} is the given radius of quintessence; G=9r_{q}²c⁴/λβE (3), such that the Universal wave equation is in direct agreement with general relativity.³ Thus special and general relativity and quantum mechanics can be unified.

From here it is possible to proceed in a number of ways; the geometric structure of the electron and the forces of Nature may be derived from first principles and in turn the structure of the quarks, including the top and bottom, otherwise known as truth and beauty can be seen. Moreover, the presence of a space-time lattice results in an understanding of quantum EPR effects. By allowing a theoretical flow of energy through the space-time lattice it can be shown that:

Energy is not bound by space-time

Thus logically accounting for phenomena such as entanglement and quantum tunnelling. Quintessence can also be used to explain, logically, the inner physics of a black hole, the missing mass of the Galaxy, the continuing expansion of the Universe, Guth's inflationary theory and the Big Bang. Hence, it is now possible to understand the Universe, including space-time, matter and the forces of nature from the radius, mass and vibration of a single quantity, quintessence.

With this understanding of space-time, matter and the forces of Nature, and in particular gravity, it is possible to demonstrate that the modification of gravitational fields, and in turn the warping of space-time, can be technically readily achieved.

Using standard equations for special relativity, m′=m₀/(1−β²)^{1/2}, it can be demonstrated that by differentially increasing the velocity of electrons, by applying a differential current, their mass can be increased in a specific way. In turn by increasing the mass of electrons, by general relativity, the number of gravitons emitted from these electrons can be modulated. By multiplying this effect using an ultracentrifugational device the differential graviton emission can be manifestly amplified. This in turn, in accordance with general relativity, will cause a change in the curvature of space-time.

This effective warping of space-time does not, of necessity, imply superluminal velocities, but does allow the creation of warp drive systems, which do not depend on the creation of thrust by the ejection of material as used in current space technologies.

### Part I

### Fundamental Laws of Physics

Quintessential Mass

The quantum physical, minimum component of energy is Planck's constant; h. To define the minimal component of mass, using the standard energy equivalence formula; E=mc², such a minimal mass (m_{q}) would be required to have the value equivalent to; m_{q}=h/c² (1). The total mass of a system (m) would then be; m=m_{q}n_{q}, where n_{q} is the number of these minimal units. Thence, the total energy of a system can be derived from the minimal energy; h, multiplied by the number of these energy units (n_{q}). Thus as, E=mc², then also E=m_{q}n_{q}c² and substituting m_{q}=h/c², the energy equivalence formula has the more logical formulation; E=hn_{q} (1a). Thus the energy of a system is equivalent to the minimal energy unit; h, multiplied by the number of those minimal energy units (n_{q}).

Taking this minimal mass/energy, it is possible to show that all matter, the forces of nature and space time can be constructed from this single quintessential quantity. Moreover, using this quantity the laws of physics can be derived from first principles. Thus, a priori, all components of the physical universe, including space-time, can be constructed from this minimal mass component, termed quintessence.

Wave Particle Duality

If the presence of quintessence accounts for the structure of matter and if matter itself forms from the number of quintessences, then the frequency of matter and thus wave particle duality directly arises from first principles. Specifically the wavelength of matter derives from the vibration of quintessence from which it is constituted. Thus the frequency (f) and in turn the wavelength of light and matter is directly equivalent to the number of quintessences contained within it. We find that the actual frequency of light can be directly derived from first principles from the effective mass of the photon (m,) and thus by the number of quintessences (n_{q}) it contains.

Thus for light conventionally:

f=E/h

and if E=mc², and h=m_{q}.c², then

f=m_{γ}c²/m_{q}.c²

and

f=m_{γ}/m_{q}=n_{q}

Thus

f=n_{q} (4)

Thus the formula for the frequency of light (E=hf) is now readily explained by the observation that the frequency is determined quite directly from the number of quintessences (n_{q}) within the photon.

The wavelength is thus also given by:

λ=c/f=m_{q}c/m_{γ}=h/p

We can now show that the frequency of matter also has the same derivation from quintessence, as has the frequency of light. The frequency of matter is again equivalent to the number of quintessences it contains. Thus the wave particle duality of matter itself can be explained by its composition from quintessence. The amount of quintessences contained within a electron sphere will depend on the number of quintessences constituting the electron and those passing through it as a result of its relative velocity β² (where β=v/c); effectively its relativistic momentum (p). The frequency will then be related to the total number of quintessences. Thus for matter,

f=β²n_{q} (4a)

Thus it is possible to derive the conventional de Broglie wave equation for matter from first principles. Thus, as λ=v/f, we have:

λ=v/β²n_{q} (5)

thus as n_{q}=E/h

λ=hc/βE (2)

and as conventionally βE/c=p, then for matter:

λ=h/p

Provided that in the de Broglie equation, the momentum of the object is calculated using the relativistic mass, thus accounting for the total number of quintessences (n_{q}) in an object, this gives an accurate value for the wavelength of matter.¹

Thus the wavelength of matter follows directly from its constitutents, quintessence. As matter is made of quintessence, similarly to light, its frequency depends on the number of quintessences (n_{q}) within it, travelling relative to the speed of light. Moreover, λ=hc/βE, underpins a fundamental relationship between wavelength and energy. Furthermore, this is mathematically the same as the term λ=hv/β²E, giving a relativistic expression for the the wavelength of matter, from which the relativistic equations may be directly derived (see Wave Particle Duality and Relativity).

Wave Equations

The derivation of wave particle duality from first principles also now allows the derivation of a modified wave equation for matter.

To derive his wave equation Shrödinger commenced with the de Broglie equation using momentum (p). For lower energies the momentum of an electron is conventionally derived from the kinetic energy of the electron and the mass of the electron mo. Thus conventionally:

Eₖ=½mv^{1/2}and p=m₀v

Thus

Eₖ=p²/2m₀

then

p=(Eₖ.2m₀)^{1/2}

and conventionally, the de Broglie equation can also be written as:

λ=h/p=h/(Eₖ.2m₀)^{1/2}

In turn the Shrödinger wave equation directly derives from the square of the above classical non relativistic term for kinetic energy:

λ²=h²/Eₖ.2m₀

thus

$${E}_{k} = \frac{{h}^{2}}{2 m} \cdot \frac{1}{{λ}^{2}}$$

As E=Eₖ+V

then

$$E ψ = - \frac{{h}^{2}}{2 m} \cdot \frac{{ⅆ}^{2} ψ}{ⅆ {x}^{2}} + V ψ = jh \cdot \frac{ⅆ ψ}{ⅆ t}$$

However, the Shrödinger equation, may be refined by taking into account relativity. Thus the true values for the energy are given by the relativistic momentum (p).

A fundamental relativistic wave equation for ψ, and its logical derivation may now be developed through the concept of quintessence as a fundamental constituent of matter.

The amount of quintessences in the electron is determined by the number of quintessences forming the electron at rest, plus the amount of quintessences passing through it due to its relativistic velocity, which will determine the relativistic momentum (p) of a particle.

The frequency of matter can now be readily calculated from first principles to give a more accurate result. Thus as matter is made of quintessence, similarly to light, its frequency is equal to the number of quintessences (n_{q}) within it. The wavelength will depend on its velocity travelling relative to the speed of light and thus multiplied by the relative velocity compared to c (β=v/c);

Hence for matter as previously shown:

λ=v/β²n_{q}=hc/βE (2)

And conventionally

E=(p²c²+m₀²c⁴)^{1/2}

Using these equations, we can now, also, reformulate the Shrödinger wave equation, which has the advantage that relativity can be treated in a quantum mechanical way. Thus if the wave energy of matter is defined as:

E_{λ}=β(p²c²+m₀²c⁴)^{1/2}/c²

thus

E_{λ}=(β²p²/c²+β²m₀²)^{1/2}

which in complex space generalises to

E_{ψ}=(−jβ·∇+βm)_{ψ} (2a)

As the term α=e²/hc.4πε₀; also represents the ground state ratio of the velocity of the electron to c. Thus α=β=v/c=1/137.

Thus, also

E_{ψ}=(−jα·∇+βm)_{ψ}

This is thus the standard relativistic equation that Dirac was able to construct from the Shrödinger wave equation. This relativistic equation can be derived from the modified wave equation (2). This takes into account the relative mass energy which the quintessential wave equation (2) contains.

Where importantly the term βm is the mass m, multiplied by the ratio of the relative velocity to light β=v/c, and the term a is also essentially the relative velocity of the electron.

The Dirac equation was an empirical formula which worked mathematically, nevertheless even Dirac admitted it was not logically understood. The importance of these equations (eq. 2, 2a) is that they show that the existence of quintessence allows the waveparticle duality of matter to be explained and mathematically derived from first principles, Thus the frequency of matter or even light is simply determined by the number of quintessences it contains.

Indeed, a recent publication in Nature has suggested that the direct visualisation of the orbitals of electrons shows that these are in very close agreement with theory. However, there is a significant departure from theory, in the interstitial molecular regions, suggesting that the higher velocities of the electrons obey the modified Dirac equation (2a).Thus these orbitals were in keeping with the modified Dirac equation, which itself may be derived from the wave equation above, λ=hc/βE (eq. 2) ^{(ref 2)}

The Shrödinger wave equation will approximate to the correct values until v approaches c. Indeed the Shrödinger equation will give similar answers as that derived from equation (2a), under most experimental conditions.

However, equation 2 and its derivative (2a) may have advantages over standard Shrödinger theory with relativistic speeds. Furthermore, equation 2, conceptually shows that the wave particle duality of matter derives from the principle that the frequency of matter is directly equal to the number of quintessences it contains. Importantly it also mathematically allows relativity and quantum mechanics to be united.

With v≅c, the modified Dirac equation (2a) will yield more accurate results, particularly compared with the Schrödinger equation. We also find that the equation λ=hc/βE (2) is equivalent to the de Broglie wave equation, λ=h/p, provided we use the relativistic mass in the de Broglie equation. Given this, these equations yield accurate experimental results ^{(ref 1)}.

Thus we find that the modified formulation of de Broglie wave equation λ=hc/βE (eq. 2a) leads directly to a modified Dirac relativistic wave equation and is supported by recent experiments which measure the wavelength of matter and demonstrate the electron orbitals experimentally from these wave equations for matter ^{(ref 1,2)}.

Wave Particle Duality and Relativity

From here it is possible to proceed in several ways using the relativistic wave equation (2). It is apparent that the reintroduction of the term for relative velocity into the wave equations will enable the reintroduction of special relativity into quantum mechanics. In particular we should now be able to derive the term (1−v²/c²)^{1/2} as a special case of quantum mechanics.

Thus if:

λ=hc/βE (2)

As E=(p²c²+m₀²c⁴)^{1/2}, squaring

λ²=h²c²/β²(p²c²+m₀²c4)

Conventionally p²c²=E²v²/c²

then

λ²=h²c²/β²(E²v²/c²+m₀²c⁴)

Thus as β²=v²/c² and m₀²c^{4 =E}₀², then:

β⁴E²+β²E₀²=h²c²/λ²

hence

$${β}^{4} {E}^{2} = {h}^{2} {c}^{2} \cdot \frac{1}{{λ}^{2}} - {β}^{2} {m}_{0}^{2} {c}^{4} \\ thus \\ {β}^{2} = \frac{{h}^{2} {c}^{2}}{{β}^{2} {E}^{2}} \cdot \frac{1}{{λ}^{2}} - \frac{{β}^{2} {m}_{0}^{2} {c}^{4}}{{β}^{2} {E}^{2}} \\ As {E}^{2} {=}^{′} {m}^{2} {c}^{4} \\ {β}^{2} = \frac{{h}^{2} {c}^{2}}{{β}^{2 ′} {m}^{2} {c}^{4}} \cdot \frac{1}{{λ}^{2}} - \frac{{β}^{2} {m}_{0}^{2} {c}^{4}}{{β}^{2} {E}^{2}} \\ Substituting h = {m}_{q} {c}^{2} \\ {β}^{2} = \frac{{m}_{q}^{2} {c}^{6}}{{β}^{2 ′} {m}^{2} {c}^{4}} \cdot \frac{1}{{λ}^{2}} - \frac{{β}^{2} {m}_{0}^{2} {c}^{4}}{{β}^{2} {E}^{2}} \\ As {m}_{q} {/}^{′} m = 1 / {n}_{q} ( eq . 2 )$$

$${β}^{2} = \frac{{c}^{2}}{{β}^{2} {n}_{q}^{2}} \cdot \frac{1}{{λ}^{2}} - \frac{{β}^{2} {m}_{0}^{2} {c}^{4}}{{β}^{2} {E}^{2}} \\$$

Thus if f=β²n_{q} (eq. 7a);

$${β}^{2} = \frac{{v}^{2}}{{f}^{2}} \cdot \frac{1}{{λ}^{2}} - \frac{{β}^{2} {m}_{0}^{2} {c}^{4} {f}^{2}}{{β}^{2} {E}^{2}}$$

$$As 1 / {λ}^{2} = {f}^{2} / {v}^{2}$$

$${β}^{2} = \frac{{v}^{2}}{{f}^{2}} \cdot \frac{{f}^{2}}{{v}^{2}} - \frac{{β}^{2} {m}_{0}^{2} {c}^{4} {f}^{2}}{{β}^{2} {E}^{2}}$$

$$Thus : \\ {β}^{2} = 1 - \frac{{β}^{2} {m}_{0}^{2} {c}^{4}}{{β}^{2} {E}^{2}}$$

$$As {E}^{2} {=}^{′} {m}^{2} {c}^{\\ 4}$$

$${β}^{2} = 1 - \frac{{m}_{0}^{2}}{{}^{′} {m}^{2}}$$

$$Hence$$

$${m}_{0} {\text{/}}^{′} m = {( 1 - {β}^{2} )}^{1 / 2}$$

$$Thus {\\ }^{′} m = \frac{{m}_{0}}{{[ 1 - \frac{{v}^{2 } }{{c}^{2}} ]}^{1 / 2}}$$

Thus this derivation now allows relativity as a universal case of the quintessential wave nature of matter.

The original premises on which special relativity was based were: that the speed of light is a constant and that all observers are equal. As the speed of light has dimensions of length and time but not apparently of mass, the relativistic change in mass is not accounted for. Using quintessence logically and directly accounts for the relativistic mass changes.

Moreover, relativity can be derived from the de Broglie equation, and visa versa, directly, thus linking relativity and quantum mechanics by taking into account the existence of quintessence mass.

Hence, it is now possible to derive the relativistic equations for mass and in turn for space and time from the quintessential wave equation, thus deriving special relativity as a universal case of quantum mechanics and thus uniting special relativity and quantum mechanics. This now allows a further understanding of the nature of space-time.

The Space-Time Lattice

The understanding of the true nature of space-time and how it is formulated in three dimensions of real space is crucial. To simply assume that space-time exists, and thence not to question the nature of that existence, denies a deeper understanding of the universe.

In order to understand the nature of space-time itself, at the quantum level a further look at the nature light and the photon is necessary. Since Einstein's description of light as a particle (the photon) and the description of the photoelectric effect, the standard picture of light as simply a wave can, no longer be applied. If light was to exist as a photon, it could not exist in one dimension, as ordinary waves do, it would need to be three dimensional, with the addition of time. Let us suppose, in this case, that a photon is a three dimensional helical ringlet of light, travelling in the x vector, and spinning around the x-axis. Conventionally this ringlet has a radius; r=λ/2π. The ringlet itself would be vibrating in the y and z vectors. The vectors x, y and z would represent the photon, the substance of which, would be travelling in the x direction and oscillating in the y and z vectors, which would represent oscillatory energy. This in turn would allow it to act as a wave, and create oscillatory electromagnetic fields.

It is important to re-examine space-time itself in this light, this would have one directional vector with two vector dimensions of energy, one of capacitance and one of electrical permeability, thus accounting for the well known constants of free space; the permittivity of free space (ε₀) and the permeability of free space (μ₀) respectively. The vector dimension of direction x, would be the direction of travel and those “quintessences” travelling in an outwardly direction would account for none other than the expansion of the universe. Three of these quintessences would naturally constitute three dimensional visible space-time. These constituents of space-time would interact with the generations of the other vector dimensions reciprocally. Thus one quintessence would sweep out one vector of permeability and one vector of permittivity, through which the other two quintessences could travel, and vica versa, creating a three dimensional space-time lattice.

The permittivity of free space, (ε₀) which is equivalent to capacitance, would as with capacitance plates, be determined by the effective separation between quintessences. The permeability of free space (μ₀) is in fact a force, measured as 4π×10⁷ N A⁻², would result from the force produced by the vibration of quintessence and would be dependent on the density of quintessence. Hence these two parameters would be reciprocal and thus the product of these two would therefore be a constant, which is recognised as none other than the speed of light.

c=(μ_{0.}ε₀)^{-1/2}

This space time lattice would in effect be created by quintessences travelling in all directions with a speed of c within the lattice. The quintessences of the space time latice would in effect produce a non-static ether. A non-static ether is fully compatible with special and general relativity. Indeed such an ether explains how space time can be curved as in general relativity. Furthermore, the existence of a non-static ether, was espoused by Einstein in his University of Leyden lecture on general relativity of May 5, 1920. In Einstein's own words;

“According to the general theory of relativity space without ether is unthinkable.”^{(ref 4)}

Recent evidence from a number of sources now strongly support the presence of this non-static ether, in the form of quintessence. An editorial from a major journal states “combined with other observations such as those of distant Supernova, the QMAP results corroborate the prevailing theory of inflation with the twist that the Universe is only one third matter (both ordinary and dark) and two thirds quintessence, a form of energy possibly inherent in empty space”.^{(refs 5, 6, 7)}

If we take into account the existence of quintessence and as such a three dimensional space-time lattice, matter which is intrinsically made of contituents of charge would interact with this lattice to produce the effects of mass. Mass would be perceived as a result of matter (whose constituent particles appear to contain charge) interacting with this lattice directly due to the inhibition of motion by the lattice's electrical permeability and permittivity vectors, which would form the existence of complex space. These quintessences would in the direction in the y and z vectors produce small vibrations of the order of the Planck length (10⁻³⁵ m), whilst passing through the vectors of permeability and permittivity, thus producing the effects of mass.

The vibration would endow quintessence itself a (non rest) mass (m_{q}) equivalent, to the minimal mass of:

m_{q}=h/c²=7.373×10⁻⁵¹ kg.sec (1)

The presence and magnitude of Planck's constant (h) and especially the speed of light (c) is thus explained. Indeed, the speed of light c=(μ_{0.}ε₀)^{-1/2} is not in itself a fundamental quantity.

As the energy equivalence formula is E=mc², the minimal mass of a single quintessence, would thus be the minimal mass, h/c², hence again:

m_{q}=h[μ₀.ε₀]=h/c²=7.373×10⁻⁵¹ kg.sec (1b)

or

m_{q}c²=h (1c)

It is postulated by general relativity that the shape of space time itself can be altered, indeed the presence of the space time lattice now allows this to be altered by altering the density of quintessence. It is further clear that if quintessences underly the structure of the space-time lattice, they may also underly the structure of matter itself.

With regards a single quintessence, this passing through an energy vector of the space-time lattice would appear as a vibrating string. In a similar way to string theory, the conglomeration of these quintessences would produce the constituents of ordinary matter. Thus the general equation for the number of quintessences (n_{q}) in an object of mass (m) would be

m/m_{q}=n_{q}

The mass of the electron (mₑ) for example, would be directly determined by the number of quintessences in the electron, multiplied by the mass of quintessence.

Quintessence and Complex Space

Quintessence is postulated to constitute the fundamental nature of space-time. Three quintessences each travelling in their respective x vectors at 90° to each other would create three dimensional real space-time. These quintessences would in the direction in their respective y and z vectors produce small vibrations of the order of the Planck length (10⁻³⁵ m), this would create the vector dimensions of permeability and permittivity. The result would give space-time 9 dimensions of space as in superstring theory. However, unlike superstring theory the six hidden dimensions would not be “curled up so as to be so small as to be invisible” these six dimensions would be present in complex space. Thus, only three of these dimensions would represent ordinary three dimensional particulate space time i.e. three dimensional objects. The other six dimensions produced by the vibrations of quintessence would form complex space.

The mathematics of complex space, using imaginary √−1 or (j) numbers, is assumed in the standard formulation of the Shrödinger wave equation. Thus the presence of complex space is an integral part of quantum mechanics.^{(ref 8)}

$$- \frac{{h}^{2}}{2 m} \cdot \frac{{ⅆ}^{2} ψ}{ⅆ {x}^{2}} + V ψ {=}_{j} h \cdot \frac{ⅆ ψ}{ⅆ t}$$

The mathematics of complex space is also an essential and integral part of the principles and application of modern electronic and control engineering. Indeed it has been well recognised for some time that each direction vector in electronic engineering can , be associated with complex vectors.^{(ref 9)}

As this complex space consists of the vectors of permittivity and permeability it would only be “felt” by charged particles as in the electron. Nevertheless, as all particles are fundamentally composed of charged particles the effects of complex space would be felt by endowing these particles with mass and in turn kinetic energy.

In conventional complex space, a 2 dimensional Cartesian Argand diagram is mathematically used. However, in order to formulate the equations for particles a three dimensional Argand diagram is essential. This will have three dimensional vectors, one real vector and two imaginary vectors. Three of these diagrams will be required to fully describe the nature of particles, each with a real vector in the x, y and z vectors, respectively. Nevertheless, in the instance below the real vector is the x vector and the two imaginary vectors are given by (ⱼy, ⱼz)

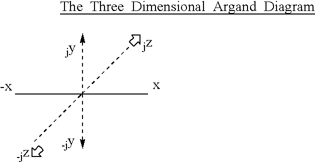

The Three Dimensional Argand Diagram

The beauty of a three dimensional Argand diagram is that the complex conjugate (i.e. the mirror image which confers mathematical reality on the coordinates) is formed by the value of the minus coordinate in the other complex vector dimension. Thus the complex conjugate of (cₓ^{1/2}+ⱼc_{y}^{1/2}+₋ⱼc_{z} ^{1/2}) is (cₓ^{1/2}+ⱼc_{y}^{1/2}+ⱼc_{z}^{1/2} ). These two sums when multiplied thus give a real number solution.

Furthermore it is clear that nine dimensions of space time are necessary in the general relativistic equations. By including complex space we thereby create the nine dimensional spacial metrictensor and the metric energy tensor of matter necessary for computations for general relativity (see quantised general relativity pp 34-35). From here we can begin to understand the true structure of matter.

Energy and the Space-Time Lattice

The presence of numerous experimental data for quantum tunnelling^{(refs 10, 11, 12, 13)} and indeed the recent observations by Nicholas Gisin, on the entanglement of distant photons now returns us to EPR experiments.

Using the quintessential modification of the de Broglie wave equation, gives us an insight into these teleportation and EPR effects.

As

λ=hc/βE (2)

and

E=hn_{q} (1a)

then

λ=c/βn_{q} (2b)

Importantly, as indicated by equation (2b), energy having no quintessence; would have a wavelength of infinity. Specifically pure energy containing no quintessences, would have a lambda of infinity. According to quantum mechanics an infinite wavelength would result in the probability of that energy being anywhere. As energy itself has no electrical charge it would not be impeded by the permittivity and permeability of the three dimensional space-time lattice. Moreover, energy would not be detectable in three dimensional space-time, unless it interacted with matter, as in the EPR experiments. Indeed, energy is not observed when not bound to any form of mass or particle. Thus equation 9d, takes us to our original assertion

Energy is Not Bound by the Space-Time Lattice

Thus, as the EPR experiments suggest the existence of energy separate from matter and thus separate from the three dimensional space-time lattice, it is interesting to find that experiment suggests the existence of free energy in a continuum separate from space time to produce the effects of quantum teleportation.^{(refs 10, 11, 12, 13)}

This is not, however, teleportation across an additional dimension, this is a term to describe in partially familiar terms the dissociation of energy from the three dimensional space-time lattice. As time is inextricably linked to each dimension of space, the effects of energy would be inextricably linked to the events, such as the creation of virtual particles, we see interacting within space-time.

It is unlikely that observers have any direct day to day experience to explain quantum events. Nevertheless, quantum physics may have given us a window into the hitherto hidden workings of the Universe. Thereby, the mystery of the uniformity of the Universe, across distances which the speed of light could not apparently traverse, is readily explained by the fact that the free energy contained in the Universe is not bound by the space-time lattice.

In the case of light, due to the exceedingly small masses involved, there would be relatively easy exchange of matter with free energy within a photon. This would make the photon the ideal experimental tool to look for energy which is not bound by matter and in turn energy which is not bound in space-time. Indeed, very recently Furusawa et at. have reported to have observed the transference of energy as photons from A to B, without those photons traversing space-time^{(ref 10)}. This finding which has been supported using other experimental techniques^{(refs 11, 12, 13,)}, is very important as it suggests the existence of such a quantum continuum.

We have already seen strong experimental data using photons^{(ref 10)}, atomic spins and other data for quantum teleportation which have recently been published ^{(refs,11, 12, 13)}, which support these findings. According to the above equations the teleportation would vary in a predictable fashion, as with photons, in line with the wavelength of the light used, relative to the size of vibration of quintessence. As regards matter, the results do confirm that the effect of quantum tunnelling is indeed dependant on the wavelength of matter and the size of that matter^{(ref 10)}.

### Part II

### Particle Physics

Electron Structure

Understanding the electron is fundamental to the understanding of the elementary particles. The hidden nature of the electron may recently have been revealed through observations by Horst Stormer, Daniel Tsui and Robert Laughlin for which a Nobel prize has recently been awarded. They describe a quasi electron particle of charge ⅓e. This has been described on a quantum basis as a vortex of energy, bound as a quasi particle in one dimesion x, but not bound in the other two dimensions y and z, allowing dispersion in space-time as a vortex. What is more intriguing are the experimental conditions in which this occurs. First of all a two dimensional electron gas is created and held between two capacitance plates. A magnetic force is then applied in the remaining dimension, virtually creating a one dimensional passage through which only a quasi electron appears to be able to pass.^{(refs 15, 16)}

Given the presence of charge of ⅓e, then three of these quasi electrons could form an entire electron in three dimensional visible space time. Nevertheless, each would have energy and hence a wave function which would be present in the other vectors. This electron could thus follow the probability functions as described by the Shrödinger wave equation for ψ (otherwise termed as “essence” by Shrödinger)

If the mass of the electron (mₑ) is constituted from quintessence, using the formula:

mₑ/m_{q}=n_{q}

Then an electron would be constituted from:

9.11×10⁻³¹ kg÷7.373×10⁻⁵¹ kg.sec=1.236×10²⁰ quintessences/sec.

Thus taking into account the mass-energy content of quintessence (m_{q}) it is independantly possible to derive the magnitude of the charge of an electron (e) using the following equation.

e=[m_{q}ε₀/4/3πhc]^{1/2}=1.61×10⁻¹⁹C

This is in close agreement with the experimentally observed charge on the electron of 1.602×10⁻¹⁹ C.

Interestingly substituting m_{q}=h/3c² in the above equation we have:

e=[ε₀/3(4/3πc³)]^{1/2} (6)

This can also be written as

$$e = {[ \frac{ϵ o}{3 ( 4 / 3 π {c}^{3} )} ]}^{1 / 2} \qquad \text{(6a)}$$

Equation (6) has a number of very special implications, if re-examined, firstly three of these quasi electron spheres appear to to be required to constitute the charge of the electron . More intriguingly, it indicates that the charge is related to the volume of a sphere with an apparent radius of c. Thirdly it indicates that the square of the charge of an electron (e) is proportional to the permittivity of free space (so). The charge given from equation (3) is in close agreement with the measured charge of the electron. Furthermore a more exact value for the charge of the electron ( to seven decimal places) can be deduced by taking into account the gravitational field of the Earth (see Gravity and the Charge of the Electron). Furthermore the charge of the electron (e) can now be derived from first principles. Thus, equation (3) corroborates the evidence that the electron is indeed composed of three quasi electrons in keeping with recent experimental findings.^{(ref 16)}

The significance of the electron, composed of three spheres each with a radius of c, is not immediately clear, but can be understood if the frequency of rotation of the electron is taken into account. Thus if the diameter of the electron was approximately 10⁻¹⁹ m, then its spin would need to be 1 /c.10⁻¹⁵ m≈10⁶ cycles/sec. Thus given a very high rotation rate an electron could have an effective radius of 1/c and still occupy subatomic sizes. Indeed these observations might be used to estimate the rate of rotation of the quasi electron and its size (see Appendix 1).

With regards a single quintessence, this passing through an energy vector of the space-time lattice would appear as a vibrating string. In a similar way to string theory, the conglomeration of these quintessences would produce the constituents of ordinary matter. The electron, for example, would be constituted from approximately 1.236×10²⁰ quintessences.

The dimensions of the equation for the electron can be readily resolved by considering each of the three vector dimensions. The exact dimensions of the equation need to be considered in the light of the nature of space-time itself. These dimensional equations help explain the nature of matter. Indeed the equation for the electron may be necessary for the full understanding of gravity, this is also fully addressed (Appendix 1, Dimensional Equations)

Complex Space and Electron Structure

The presence of complex space also now further explains the conformation of the the electron, and its formulation at the quantum level, and the presence of particles, anti-particles and their spin up and spin down characteristics.

Indeed the short form equation for the charge of the electron (−e) can now be rewritten as a metric tensor with three dimensions in real space and six in complex space.

Thus if three of the x, y and z vectors are in real space and six vectors in complex space, where c is the speed of light in the real space vector, ⱼc is the speed of light in the complex vector and ₋ⱼc is the complex conjugate of ⱼc, thus the electron can be mathematically represented by the equation:

$$- e = {ϵ}_{qe} / {( 4 / 3 π )}^{1 / 2} \cdot \begin{matrix}{( {c}_{x} )}^{1 / 2} & \cdot {( {jc}_{y} )}^{1 / 2} & \cdot {( - {jc}_{z} )}^{1 / 2} \\ + & + & + \\ {( - {jc}_{x} )}^{1 / 2} & \cdot {( {c}_{y} )}^{1 / 2} & \cdot {( {jc}_{z} )}^{1 / 2} \\ + & + & + \\ {( {jc}_{x} )}^{1 / 2} & \cdot {( - {jc}_{y} )}^{1 / 2} & \cdot {( {c}_{z} )}^{1 / 2}\end{matrix} \qquad ( 7 )$$

Which now elegantly gives the real number solution

e=ε_{qe}/3(4/3πc³)^{1/2}

Where ε_{qe} is given as the permittivity of free space for a single quasi electron (see appendix 1). Equation 4 represents a “complex” tensor

Whilst the two dimensional Argand diagram has four quadrants, the three dimensional Argand diagram has eight cubic sectors. Two of these cubic sectors are diametric opposites and can represent “real” particulate objects. These have the primary coordinates x, y, −z; as in the electron described above, and the −x, −y, z, with the real vector x now having a minus sign. These two “real” cubic sectors, therefore, mathematically represent particles and their anti-particles.

The mathematical presence of the two primary diagonal mirror images (x, y, −z and −x, −y, z) now allow the introduction of the concept of antiparticles. This extension of the maths into a three dimensional Argand diagram thus results in the automatic formulation of the maths of antiparticles. Thus the charge of the positron (⁺e) is formulated by the shortened form equation, where the real vectors now each have the minus sign, and therefore exist in the −x, −y, z sector of the three dimensional Argand diagram.

$$e = {ϵ}_{qe} / {( 4 / 3 π )}^{1 / 2} \cdot \begin{matrix}- {c}_{x}^{1 / 2} & {\cdot }_{- j} {c}_{y}^{1 / 2} & {\cdot }_{j} {c}_{z}^{1 / 2} \\ {}_{j} {c}_{x}^{1 / 2} & \cdot - {c}^{1 / {2}^{y}} & {\cdot }_{- j} {c}_{z}^{1 / 2} \\ {}_{- j} {c}_{x}^{1 / 2} & {\cdot }_{j} {c}_{y}^{1 / 2} & \cdot - {c}_{z}^{1 / 2}\end{matrix} \qquad ( 8 )$$

The three dimensional Argand diagram also accounts for chirality and indeed the up and down spin of the electron. There are two other “real” primary coordinates in the Argand diagram, these are themselves the partial mirror images of the above coordinates (i.e. x, −y, z and −x, y, −z). In particular the y axis is of the opposite sign, thus in particles the y axis is in the downward direction, to form down spin particles and in anti-particles in the up direction, to form the antiparticle The up spin electron is given by eq. 8 and hence the down spin electron (−e|↓≦) is given by the equation

$$- el ↓ ⟩ = {ϵ}_{qe} / {( 4 / 3 π )}^{1 / 2} \cdot \begin{matrix}{c}_{x}^{1 / 2} {\cdot }_{- j} {c}_{y}^{1 / 2} {\cdot }_{j} {c}_{z}^{1 / 2} \\ \begin{matrix}{}_{j} {c}_{x}^{1 / 2} \cdot {c}_{y}^{1 / 2} {\cdot }_{- j} {c}_{z}^{1 / 2} \\ {}_{- j} {c}_{x}^{1 / 2} {\cdot }_{j} {c}_{y}^{1 / 2} \cdot {c}_{z}^{1 / 2}\end{matrix}\end{matrix} \qquad ( 9 )$$

Thus the three dimensioanl Argand diagram accounts directly for the presence of antiparticles and the spin up and spin down particles seen in nature. It also accounts for the necessity of the electron to form a square root spherical object, as complex space depends on √−1, otherwise known as j.

Electron Pairing and Superconductivity

As the quintessences making up the electron are in a square root conformation, each of these quasi electrons would have a tendancy to pair to form an entire sphere.

The square root sphere structure of electrons with up and down spins can now superimpose to produce a complete sphere of varying extents. This produces electron pairing as seen at the atomic and molecular levels. It also accounts for the Pauli exclusion principle. This pairing thus accounts for the reactivity of the valence electrons and the electron probability densities, which in turn accounts for the existence of chemistry.^{(ref 8)}

Furthermore, it is possible to account directly for superconductivity from first principles. For if both the complex and real vectors of the electron combine completely, the product of an up and down spin electron form a perfect superimposed sphere with radius c, with a charge of 2.59×10⁻³⁸ Coulombs, denoted by the formula:

$${e}^{2} = \frac{ϵ o}{3 ( 4 / 3 π {c}^{3} )} = 2.59 \times {10}^{- 38} C \qquad \text{(6b)}$$

As with standard superconducting theory, superconductivity can be explained by the formation of “Cooper” electron pairs, where the electrons are forced to pair by the presence of positve crystal charge in particular formation, at supercooled temperatures. In addition the electron pair now forms a stable entity whose angular momentum cancels.^{(ref 8)}

It additionally becomes clear that the charge of two seperate electrons (2e) is 3.2×10⁻¹⁹ C, but the charge of the combined electrons (e²) is 2.59×10⁻³⁸ C. This electron pair thus appears to have 19 orders of magnitude less charge than the electron and in turn 19 orders of magnitude less resistance. It is this effective reduction in charge and in turn resistance which may account for superconductivity. When observed directly any electrical interaction with the Cooper electron pair will, however, result in the release of the full charge of both electrons, so that the full electrical charge put in will be equal to that coming out of the apparatus.

The Fine Structure Constant

Intruiginty from our knowledge of the electron we can further define the term α, the fine structure constant; from the structure of the electron. Thus as the standard term α=e²/hc.47πε₀; substituting the term e²=ε₀/3(4/3πc³) (eq. 6) and h=m_{q}c² (eq. 1) we find:

2π/α=m_{q}[3(4/3πc³)]²

*or

2π/α=m_{q}e⁴/ε₀²

For brevity we may represent the quasi electron structure as (4/3πc³)=Θ; to signify its threefold symmetry, thus

2π/α=m_{q}[3Θ]² (10)

Indicating that the fine structure constant of the electron (α) is indeed related to its dimensional structure. Again taking into account the effects of gravity the fine structure constant can be derived from first principles to nine decimal places (see Gravity and the Charge of the Electron).

Fundamental Forces and Particle Structure

In order to understand the fundamental forces and the nature of fundamental particles, an overview is required. Thus, there are three major forces; strong, electro-weak and gravity, each mediated by three force particles the gluon, photon and graviton respectively. These in turn, influence three types of particle, the quark, lepton, and by general relativity space-time itself. Each of these are composed of particles with multiples of charge of ⅓, which are themselves in three generations, and are present in three dimensions of real space. It is important that a comprehensive view of nature explains this threefold symmetry.

Using the Standard Model of particles, it is well accepted there exist quark particle charges of −⅓, −⅔ and +⅓ and +⅔ in quarks and anti-quarks. Given that each particle is made up of three quarks the presence of these fractional charges support the association of the fractional charges in this way to form three dimensional charged particles. In stable particles each of the three quarks would have a vector in one dimension, giving the three quarks together an existence in three dimensional visible space time. The particles that bind the quarks (gluons) are themselves required, in stable particles, to have three different colour charges, one colour in each dimension, for the particle to exist in three dimensional space-time. Furthermore, there are three generations of quarks (and indeed leptons).

The Standard Model (or a modification of this) and in particular the observation of quarks and indeed quasi electrons with fractional charge of ⅓ and ⅔ in both cases, indicates that particles are constituted from the equivalent of three of these quasi particles to form an electron and quarks to form baryons. In the normal three dimensions the energy would be carried by the particle, However, because each particle is constituted of three quasi particles and in each quasi particle or quark one visible dimension would be the direction vector, in the other two hidden dimensions of each vector the waves would carry energy. Thus each particle would be associated with vibration, which would account for wave particle duality and Heisenbergs uncertainty principle in three dimensional visible space-time.

These observations lead us directly to the previous postulate that the structure of the electron is composed of none other than three (root) spheres, and that this equation for the electron allows the determination of the charge of the electron from first principles, thus:

$$e = \frac{{ϵ0}^{1 / 2}}{[ 3 ( 4 / 3 π {c}^{3} ) ]} \qquad ( 6 )$$

In addition the mass of the proton (mₚ) can be directly calculated from the ratio of the mass (mₑ) of the electron, given by the equation:

mₑ/mₚ=5.45×10⁻⁴=3(π/c^{1/2}) (11)

Strictly we should write, mₑ/(mₚ+mₑ)=3πc^{1/2}; which is much more elegant.

Which now gives

mₑ/mₚ=1/(c^{1/2}/3π−1)=5.4462×10⁻³

This is in very close agreement with the experimentally derived ratio of the proton to electron masses which is also; 5.4462×10⁻³

Thus the correlation factor between theory and experiment has a maximum error <0.00001 ^{(ref 17)}

If we combine equation 3: e=[ε₀/3(4/3πc³)]^{1/2} and equation 13: mₑ/mₚ=3(π/c^{1/2}) the positive charge of the proton (eₚ) is given by:

eₚ=[ε₀/3(4/3πc³)]^{1/2}×mₑ.3(π/c^{1/2})/mₚ=e (12)

The stable nuclear proton conformation can thus be represented by the short form equation:

p=3⁺(4/3πc³)^{1/2}.3(π/c^{1/2}) (13)

This forms a stable 3×3 conformation as with the stable electron structure.

Importantly the term (π/c^{1/2}) is the 90° solution to the Shrödinger wave equation for an electron confined in a space with radius c! ^{(ref} 8)

Thus the standard equation for an electron confined in a one dimensional box is given by:

$$E ψ ( x ) = - \frac{{h}^{2}}{2 m} \frac{{ⅆ}^{2} ψ ( x )}{ⅆ {x}^{2}}$$

If the one dimensional box has a length 2L the quantum amplitude (A) can only be non zero between x=0 and X=2L and the standard solution for the amplitude is none other than:

A=(1/L^{1/2})

Thus in one dimension the standard solution to the Shrödinger wave equation is:

ψ(x)=(π/L^{/12})sin x/L

Thus not only is the electron charge derived from the equation for three spheres each with a radius of c (eq. 3); but the proton mass and charge can also be derived from the standard solution to the Shrödinger wave equation for a an electron confined in a space of radius c! ^{(ref 8)}

The term (π/c^{1/2}) itself would thus most logically represent the gluon which is present in the proton. These gluons would bind the quasi electrons together to form the fundamental particles

The masses of all the known particles, including the up and down quarks, the W boson, the muon, charm, strange, the tauon, truth and beauty can thus also be derived from first principles in this fashion, and have the quasi electron as their basic constituent particle (see Appendix 1).

Thus the structure of the muon (μ) can also be derived from the ratio of the mass of the electron (mₑ) and the mass of the muon (m_{μ}):

mₑ/m_{μ}=4.7×10⁻³=/c^{1/3}

Thus

[μ=ε₀^{1/2}.mₑ/m_{μ.}3⁻(4/3πc³)^{1/2}.(π/c^{1/3})

Where the charge of the muon is in this equation equivalent to that of the electron e. In this case (πc/^{1/3}) can be considered to represent a specific high energy photon. Thus the structure of the muon, written in short form is:

μ=3⁻(4/3πc³)^{1/2}.(π/c^{1/3}) (14)

Moreover the structure of the tauon can be calculated from the ratio of the mass of the electron and that of the Tauon (1.79 Mev);

Thus

0.511 Mev/1.79 Gev=2.85×10⁻⁴

mₑ/mᵣ=(π/c)^{1/3}.(π/c)^{1/9}=2.85×10⁻⁴

As the charge of the tauon is equivalent to the charge of the electron, hence the structure of the Tauon is given by the above equation

e_{τ}=ε_{qe}.mₑ/m_{τ}.3⁻(4/3πc³)^{1/2}.(π/c)^{1/3}.(π/c)^{1/9}=e

This equation accurately predicts the charge −1; and mass of the Tauon (˜1.78 Gev)^{(ref 1)}. Thus the structure of the Tauon can in short form be given by the equation

τ=−3(4/3πc³)^{1/2}.(π/c)^{1/3}.(π/c)^{1/9} (15)

Furthermore a more exact value for the mass of the muon and tauon can be deduced by taking into account the gravitational field of the Earth (see Gravity and the Charge of the Electron pg. 17) in a similar way to identifying the exact charge of the electron. In addition it may be necessary to take into account a possible mass value of the neutrino to arrive at a precisely accurate mass value of the muon and tauon. Nevertheless, the mathematical proof of these short form equations lies in the fact that they can very closely identify the charge and the masses of these particles, from first principles, as in equations (6, 13-27, see Appendix 1).

Overall the mathematical geometrical structure of all the particles can be derived from the quasi electron, which is in turn derived from quintessence. Thus, the short form particle structures can now be derived from first principles. This includes the quasi electron (qe) and electron (e), from which the quarks (u,d) and in turn the stable proton (p) and stable neutron (n) and alpha particle (α) respectively are derived. The general structure of the force carrying bosons the photon. (g) and the gluon (γ) and the intermediate vector boson (W) can be given. It will also intriguingly be possible to derive, according to their generation, the structure of the strange (s) charm (c), beauty (b, or bottom) and truth (t or top) quarks directly from the structure of the muon (μ) and Tauon (τ) respectively.

Using the term Θ=(4/3πc³), where, −/+ represents the charge of the quasi electron, we find:

1st Generation:

qₑ=⁻Θ^{1/2} (6c)

e=3⁻^{1/2} (6)

d=⁻Θ^{1/2}.3(π/c^{1/2}) (16)

u=2⁺Θ^{1/2}.3(π/c^{1/2}) (17)

s=⁻Θ^{1/2}.3(π/c)^{1/2} (18)

2nd Generation

μ=3⁻Θ^{1/2}.(π/c^{1/3}) (14)

c=2⁺Θ^{1/2}.(π/c^{1/3}).(π/c^{1/4}) (19)

b=⁻Θ^{1/2}.(π/c/^{1/9}).(π/c)^{1/4} (20)

3rd Generation

τ=3⁻Θ^{1/2}.(π/c)^{1/3}.(π/c)^{1/9} (15)

t=2⁺Θ^{1/2}.(π/c)^{1/3}.(π/c)^{1/9}.(π/c) ^{1/4} (21 )

Particle Gluons (g):

g₁=(π/c^{1/2}) (22)

g₂=(π/c)^{1/2} (22a)

g₃=(π/c^{1/4}) (22b)

g₄=(π/c)^{1/4} (22c)

Particle Photons (γ):

γ₁=(π/c^{1/3}) (23)

γ₂=(π/c)^{1/3} (23a)

γ₃=(π/c^{1/9}) (23b)

γ₄=(π/c)^{1/9} (23c)

Intermediate Vector Boson (W^{+/-}):

W⁺=3⁺Θ^{1/2}.2(π/c^{1/6})⁶ (24)

W⁻=3⁻Θ^{1/2}.2(π/c^{1/6})⁶ (25)

Stable* Proton:

p=3⁺Θ^{1/2}.3(π/c^{1/2}) (13)

Stable* Neutron:

$${Stable}^{*} Neutron \text{:}$$

$$n = \begin{matrix} {}^{+} Θ {↓}^{1 / 2} \cdot 2 ( 3 π / {c}^{1 / 2} ) {\cdot }^{-} Θ {↑}^{1 / 2} \\ {}^{+} Θ {↓}^{1 / 2} \cdot 2 ( 3 π / {c}^{1 / 2} ) {\cdot }^{-} Θ {↑}^{1 / 2} \\ {}^{+} Θ {↓}^{1 / 2} \cdot 2 ( 3 π / {c}^{1 / 2} ) \cdot {Θ}^{-} {↑}^{1 / 2}\end{matrix} \qquad ( 26 )$$

* Stable nucleonic neutron and proton conformations differ slightly from the Standard Model, this is due to the sharing of quasi electron and quasi positron particles within the nucleus, which allows stabalisation of these particles by the formation of stable 3×3 structures. The Standard conformations which describe non-nucleonic neutrons and protons are additionally given in Appendix 1.

Alpha particle (α):

$$Alpha particle ( α ) \text{:}$$

$$\begin{matrix} α = \begin{matrix}[ {3}^{+} Θ ] {↓}^{1 / 2} \cdot 2 ( 3 π / {c}^{1 / 2} ) \cdot [ {3}^{-} Θ ] {↑}^{1 / 2} \\ [ {3}^{+} Θ ] {↑}^{1 / 2} \cdot 2 ( 3 π / {c}^{1 / 2} ) \cdot [ {3}^{+} Θ ] {↓}^{1 / 2} \\ [ {3}^{-} Θ ] {↓}^{1 / 2} \cdot 2 ( 3 π / {c}^{1 / 2} ) \cdot [ {3}^{+} Θ ] {↑}^{1 / 2}\end{matrix} & \end{matrix} \qquad ( 27 )$$

The mathematical proof for these structures and their decay mechanisms is lengthy and is thus fully contained in Appendix 1. All the particle structures are accurately mathematically defined by the masses of these particles.^{(ref 17)}

The structure of these particles all contain the quasi electron and thus the metric tensor structure necessary in the formulation of the gravitational equations is sustained. The respective forces created by the gluon and the photon are important as they tell us the behaviour of matter and also lead to the likely structure of the graviton

Particle Spin and Size

The significance of the electron, composed of three spheres each with a radius of 1/c, is not immediately clear, but can be understood if the frequency of rotation of the electron is also taken into account. Knowing the structure of the electron has led us to deduce its charge and thus may lead us estimate its size and spin. Thus these observations might be used to calculate the radius and rate of rotation of the electron.

Let us suppose, that nature is truly beautiful, and that the radius of the fundamental quasi electron is indeed 1/c, and in turn the radius was balanced by the velocity of rotation 2π/c. This can be directly confirmed mathematically by taking into account the known spin of the electron, h/4π. Thus the actual spin of the electron may be calculated form the known energy of the spin.

The radius of the electron is not up till now known, but the radius of a quark has been estimated, and this is the radius derived from deep inelastic collisions of the proton. These estimates reveal a radius of approx. rₚ=1.18×10⁻¹⁵ m.^{(ref 13)} This value may be used to assist in confirming the spin of the proton in revolutions per sec. (revs) and in turn the spin and size of the electron. Firstly we may proceed to estimate the spin of the proton. Thus as h=E.t (Joules×sec) and E.t=F.d.t (Joules×sec), then the spin;

h/4π=F.d.t (28)

As F=ma, where a=(revs. 2π)²r_{qu} and m=the mass of the proton, then

h/4π=m(revs.2π)²rₚ.d.t

The actual distance (d) travelled in a circle of half integer spin in 1 second is: revs.πrₚ, thus:

h/4=m(revs.2π)³rₚ²/2

Hence:

revs=³√[h/m(2π)⁴rₚ²]

Taking the effective mass the proton as 1.6726×10⁻²⁷ kg, then the rate of spin of the proton in revolutions/sec is:

revs=5.65×10⁶ cycles/sec

From the frequency of the specific rotation of the proton, given the half integer spin associated with the proton, we can thus mathematically confirm the relationship between the radius of a particle and its spin:

rₚ×revs/2=1/c (29)

Furthermore, the fundamental radius of 1/c seen in geometric structure the quasi electron, is also reflected in the rotation rate and radius for the proton, thus as above 1/c÷½revs=1.18×10⁻¹⁵ m. Moreover, this means the actual half integer velocity of rotation is none other than 2π/c in metres/sec. So that the particle is in harmonic balance.

Using the fundamental formula h/4π=F.d.t, it is possible to obtain accurate estimates of the radius and spin rates of the electron, or indeed any particle, using the same principle of harmonic balance. Using the formula:

revs=³√(h/m (2π)⁴rₑ²]

It appears there are two unknowns, the radius if the electron and its revolution rate, however, in accordance with the equation, rₚ=2/c.revs, which gives the revolution rate of the proton, the same principle may also be used for the electron, by substituting rₑ=2/c.revs, such that:

revs=hc²/4mₑ(2π)⁴ (30)

Taking the mass of the electron 9.109382×10⁻³¹ kg, the rate of revolution of the electron is:

revs=1.048×10¹⁰ cycles/sec

Which gives a predicted radius of the electron as

rₑ=6.366×10⁻¹⁹ m.

So the half integer rotation velocity (revs.πr) is 2π/c !, for the electron in keeping with the harmonic balance of the electron.

The same principle may be used to obtain an accurate estimate of the spin and radius of the muon, or any other particle. Using the above formula

revs=hc²/4mₑ(2π)⁴ (31)

Then as the mass of the muon is 1.8823×10⁻²⁸ kg then the revs of the muon f_{μ}=5.070×10⁷ cycles/sec and the radius (r_{μ}) is thus 1.316×10⁻¹⁶ m.

It is now possible to begin to explain how the muon and the other subatomic particles are formed. If a quasi electron is complexed with another structure the total geometric structure needs to maintain harmonic balance. So the frequency of rotation would need to match geometric sructure with which the quasi electron was complexed

Intriguingly we find asymptotic convergeance for the formulas for frequency and mass occurs, when the geometric structure complexed with the quasi electron has the structure represented by (π/c^{1/3}) [giving the frequency divided by two, because the single integer spin of the force carrying particles compares to a half integer spin for the muon]. So that

(f_{γ}3π/2)^{1/3}=f_{μ}

When the ratio of the masses of the electron (mₑ) and muon (m_{μ}) are related, such that:

mₑ(3π/c^{1/3})=m_{μ}

Indeed we find that (allowing for the neutrino) this ratio is very close to the actual ratio of the mass of the electron to the mass of the muon, determined experimentally.

Furthermore, we have seen that these geometric structures, representing harmonics of the speed of light, which either match the frequency or the amplitude of vibration of the quasi electron, mathematically define the masses of the particles and the fundamental forces of Nature.

### Part III

### Quantum Gravity

Quantum General Relativity

Given the overall energy “complex” energy tensor structure of the electron and the metric tensor, assumed in general relativity, the quantum nature of gravity itself can now be explored. The spherical complex tensor for the electron and the positron (eq. 4, 5, 6) give the mathematical quantum structure and energy tensor for all the other particles (see appendix 2). Together with the time dimension these nine space dimensions account for the 10 parameters present in the metric tensor necessary to formulate the equations for gravity using Riemann geometry and thus forms the basis of quantum gravity. Intriguingly the metric tensor at each point in space time is required to consist of a collection of ten numbers, Consequently, ten dimensional space-time hypotheses, such as this or superstring theory, do automatically yield general relativity.^{(ref 3)}

Furthermore, the mathematical representation of the graviton and the gravitational constant may be directly estimated from the knowledge of the mass and radius of quintessence. Thence, the force of the vibrations of quintessence lead directly to quantum gravity.

The radius of quintessence should be approximately in keeping with the Planck length estimate (r), which is conventionally derived from the standard dimensional equation:

r_{q}²≈Gh/c³ (32)

Given the nine spacial parameters present in the metric tensor, used in general relativity we find that the actual formula for r_{q}² is mathematically in agreement with theory when:

9r_{q}²=Gh/c³ (33)

This again supports the 9 dimensional view of space and the size of the vibrations of quintessence can thus be estimated.

r_{q}=1.35×10⁻³⁵m (33a)

This value is in agreement with the Planck length. Indeed if the above equation is correct then we find that we can derive the standard equation for the general relativistic increase in radius, r′, (eq. 34) directly from first principles and arrive at a more fundamental equation for quantum gravity. As

r′=G.M/3c² (34)

By substituting eq 33) into equation 34, a fundamental relationship between r′ and M is obtained.

r′/3r_{q}²=GMc³/Ghc²=Mc/h

And substituting the quintessential equation, h=m_{q}c² (eq. 1) then:

r′/3r_{q}²=M/m_{q}c=n_{q}/c (35)

Hence the ratio of the change in radius to that of the radius of quintessence squared, is proportional, by a factor of c, to the ratio of the mass M of an object to that of the mass of quintessence, effectively the number of quintessences. Thus the change in radius, r′ due to gravitation, is related to none other than the ratio of the mass and radius of an object to the mass and the square of the radius of quintessence. Thus again the gravitational change in radius is directly related to the number of quintessences.

Naturally, this would be exactly what would be logically expected if quintessence, like the equation for the charge of the electron (eq. 6) forms from a root sphere. Thus the change in spacial radius of a normal sphere is dependant on the square of the quintessential radius.

This increase in apparent radius represents none other than the (gravitational) binding energy for quintessence.

The meaning of the above dimensional equation (33) might itself be further understood by substituting the mass of quintessence (where m_{q}=h/c²) into the equation. Thus in nine dimensions the gravitational constant (G) may be more logically given as,

9(πr_{q}²/m_{q})=Gπ/c (36)

Where πr_{q}² is the cross sectional area of quintessence and m_{q} is the effective mass of quintessence, and thus (πr_{q}²/m_{q}) represents the effective mass per unit area which quintessence exerts. This equation reduces to:

9r_{q}²/m_{q}=G/c (37)

From this we may derive the standard general relativistic relationship for the apparent change in radius (r′) around a mass (M), from an understanding of the mass (m_{q}) and number (n_{q}) of qiuntessences. As m_{q}=M/n_{q}, then:

3r_{q}²=G.M/3c.n_{q} (38)

Then if

n_{q}=r′c/3r_{q}² (39)

thus directly substituting for n_{q} in eq 38:

r′=G.M/3c² (34)

The importance of this is that the gravitational change in radius now logically derives from equation 36, which describes the gravitational force as resulting directly from the mass of quintessence exerted/per unit area of quintessence.

9(πr_{q}²/m_{q})=Gπ/c (36)

Thus equation 34 is the conventional equation for the general relativistic increase in radius (r′) in a gravitational field, which is here derived from the underlying nature of quintessence. Thus the gravitational constant is derived from the mass and radius of vibration squared of quintessence from first principles.

Indeed it is apparent that a more fundamental equation for gravitation now exists, for equation (39) is mathematically accurate and numerically agrees with eq. 34:

r′/3r_{q}²=n_{q}/c (39)

These equations may be readily mathematically verified. If in accordance with standard general relativity, the apparent increase in radius r′ is:

r′=GM/3c² (34)

Then given that the mass of the Earth is 5.974×10²⁴ kg;

r′=1.478×10⁻³ m

Accordingly if r′=3r_{q}²n_{q}/c; (eq.39). Given the number of quintessences (n_{q}) constituting the Earth is M_{E}/m_{q}, then

n_{q}=5.9745×10²⁴/7.3725×10⁻⁵¹=8.104×10⁷⁴

As r_{q}²=1.823×10⁻⁷⁰ (eq. 33a) then:

r′=1.478×10⁻³ m

Thus equation 39 gives the same answer as the standard equation and may be understood on a logical basis. Indeed the meaning of c in the equation may be understood as it has been previously shown as being the basis for the radius of matter (eq. 6). Hence the general relativistic change in radius, r′, is none other than the effective binding energy for quintessence.

Quantum Gravity and Wave Particle Duality

Quantum gravity can now be readily linked with quantum mechanics, indeed any observations which are self consistent must be able to do so easily.

The frequency of light has been previously derived

f=E/h=n_{q}

Thus the formula for the frequency of light (E=hf) has previously been explained theoretically by the simple observation that the frequency is determined quite directly from the number of quintessences (n_{q}) within the photon. The same principle has also been shown to apply to matter.

Let us now follow these equations for matter by calculating the wavelength of a photon from the Gravitational constant as an example; and also as a test of these observations and to demonstrate that the gravitational equations can also apply to the quantum world.

If

n_{q}=r′c/3r_{q}² (39a)

where r′ is the is the general relativistic increase in radius, and r_{q} is the radius of quintessence (eq. 33). Where f=n_{q}, substituting for n_{q}, then the frequency of the photon f_{γ}(where β=1) is given by:

f_{γ}=r′c/3r_{q}²

Uing the standard equation, r′=GM/3c² (eq. 34); we may substitute for r′, thus we have:

f_{γ}=GM/9r_{q}²c

$$\begin{matrix}Thus \\ {f}_{γ} = \frac{G}{9 {r}_{q}^{2} {c}^{3}} \cdot {m}_{γ} {c}^{2} \\ and as E = {m}_{γ} {c}^{2} ; & \\ {f}_{γ} = \frac{GE}{9 {r}_{q}^{2} {c}^{3}} & ( 40 )\end{matrix}$$

Indeed as 9r_{q}²=Gh/c³, then

f_{γ}=E/h=n_{q}

It is possible to also demonstrate that the same relationship holds for the wave equation for matter. If we take the relativistic wave energy of matter, which has been previously derived,

f=β²n_{q}

This includes the term for the number of quintessences flowing through the electron, in the complex vectors of space-time, to give the relativistic electron momentum (ρ) and a term for the rest mass, thus substituting into (40)

$${f}_{γ} = \frac{GE}{9 {r}_{q}^{2} {c}^{3}} \qquad ( 40 )$$

As f=β²n_{q} for matter then the equation expands to:

$$\begin{matrix}{f}_{m} = \frac{G}{9 {r}_{q}^{2} {c}^{3}} \cdot {β}^{2} E \\ As λ = v / f , then & \\ λ = \frac{9 {r}_{q}^{2} {c}^{3} v}{G {β}^{2} E} & ( 41 )\end{matrix}$$

Then the equation again reduces to:

$$G = \frac{9 {r}_{q}^{2} {c}^{4}}{λβ E} \qquad ( 3 )$$

Equations 3, 40 and 41 are important as they show that the quantum wavelength of any particle of rest mass m can be derived from the gravitational constant G. Thus linking quantum mechanics to quantum gravity.

It is therefore important to confirm the numerical accuracy of the above equation (40). We can do this by comparing the result to the standard computation of the de Broglie equation, in a range where de Broglie itself is likely to be most accurate; which according to these observations is in the low energy range (see section on Wave Particle Duality).

If we take an electron with an energy of 0.1 KeV the wavelength is conventionally given (where the kinetic energy of the electron E_{K} is given by the product of the charge of the electron (C) and the potential applied eV=0.1 Kev), by the standard equation:

λ=h/p=h/(Eₖ.2m₀)^{1/2}

thus

λ=6.63×10⁻³⁴/[1.602×10⁻¹⁹×1×10²×18.22×10⁻³¹]^{1/2}

hence

λ≅1.23×10⁻¹⁰ m

Using

$$λ = \frac{9 {r}_{q}^{2} {c}^{4}}{G β E} \qquad \text{(3a)}$$

Where E=γm₀c²

At 0.1 Kev, electron velocity is 6×10⁶ r/sec, thus β=2×10⁻² and γ=1/(1−v²/c²)^{1/2}=1.0002 Thus:

$$λ = \frac{9 \times 1.82 \times {10}^{- 70} \times 80.78 \times {10}^{32}}{6.67 \times {10}^{- 11} \times β \times 1.0002 \times 9.11 \times {10}^{- 31} \times 8.998 \times {10}^{16}}$$

$$λ = \underline{1.21 \times {10}^{- 10} m}$$

Divergence between the de Broglie equation and the above equation (2) occurs at intermediate and high energies where it is generally accepted that the standard de Broglie equation may be less accurate ^{(ref 18)}. The values for eq. 2 and de Broglie are compared to recent experiments, which demonstrate a relativistic curvilinear plot for wavelengths of matter in keeping with eq. 40.^{(ref 1)}

The de Broglie equation in the non-relativistic format yields a simple log/linear scale, which is not in keeping with relativity; whereas eq. 3 is dependent on relativity and mathematically accounts for both relativity in calculating the wavelength. Indeed recent experiment on quantum tunnelling through a wire mesh strongly suggests that the relationship between energy and wavelength is relativisticalty curvilinear.^{(ref 1) Furthermore equation} 3a suggests a fundamental relationship between energy (E), relative velocity (v/c =β), gravity (G) and the quantum wavelength (λ)

$$λ = \frac{9 {r}_{q}^{2} {c}^{4}}{G β E} \qquad \text{(3a)}$$

Indeed as ⁹r_{q}² =Gh/c³, then

λ=hc/βE (2)

Equation 2 is the very same as the Universal wave equation derived form first principles for the wavelength of tight and matter, which allowed a relativistic solution to the equations for wave particle duality (see Wave Particle Duality). This now indicates that these quintessential equations are compatible with relativity, quantum mechanics and quantum gravity.

Graviton Structure

From these observations, if the value for the gravitational constant is substituted into the equation (35) we may now estimate the probable geomteric structure of the gravtion, which is the force particle mediating gravity by acting on quintessence. Thus the Gravitational constant has been previously derived from the vibration of quintessence by the equation:

G.(π/c)=9(πr_{q}²/m_{q}) (36)

This is in accurate agreement with the value for G (6.67×10⁻¹¹ N m² kg⁻²). This suggests that the most probable mathematical representation of the graviton (φ), the third force carrying particle is

φ=(π/c). (42)

Thus the gravitational constant (G) can be given by the mass and radius of quintessence and the structure of the graviton

G=9πr_{q}²/φ.m_{q} (43)

This shows the gravitational force to be related to the fundamental radius of quintessence space time, and the graviton.

Quantised General Relativity

The classical general relativistic formula, as given by Einstein is:

R_{μv}−½g_{μv}R=−κT_{μv}

Where R is effectively the curvature of space-time, R_{μv} denotes the contracted Riemann tensor of curvature and T_{μv} is the “energy tensor” of matter.^{(ref 3)}

If we substitute the energy tensor matrix of the electron (eq. 9) x time, for the energy tensor of matter T_{μv}; and the metric tensor of the space-time lattice x time for the contracted Riemann tensor we can arrive at the same solutions for general relativity.

Furthermore, in his published paper on General Relativity, Einstein^{(ref 3)} defined the constant κ as:

κ=8πG/c²

Therefore Einstein's equation should be written as

$${R}_{μ v} - 1 / 2 {g}_{μ v} R = - \frac{8 π G}{{c}^{2}} \cdot {T}_{μ v} \qquad ( 43 )$$

Einstein himself was apparently not happy about the right hand component of the equation. However, we find that this part of the equation can now be explained and quantised by substituting the gravitational constant, G=9πr_{q}²/φ.m_{q}, (eq. 42a),

Giving:

$${R}_{μ v} - 1 / 2 {g}_{μ v} R = - \frac{8 {π}^{2} \cdot 9 {r}_{q}^{2}}{ϕ \cdot {m}_{q} \cdot {c}^{2}} \cdot {T}_{μ v} \qquad ( 44 )$$

By substituting m_{q}.c²=h, and further substituting h=h/2π, we arrive at a quantised solution to Einstein's equations. Where A_{q} is the surface area of quintessence (A_{q}=4πr_{q}²); φ is the graviton [φ=(π/c)] and h is Plancks constant. thus:

$${R}_{μ v} - 1 / 2 {g}_{μ v} R = - \frac{9 {A}_{q}}{ϕ \cdot ℏ} \cdot {T}_{μ v} \qquad ( 45 )$$

The gravitational equation can now be further understood on a logical basis. The term A_{q}=(4πr_{q}²), where (4πr_{q}²) represents standard term for the surface area of a sphere of quintessence for the 9 space dimensions of the space time lattice, h is the energy content of quintessence x time and φ is the graviton, thus the right hand term now represents a true “metric energy tensor” of matter.

This leads directly to the standard solution to the field equations, for the general relativistic increase in radius r′ of an object, where A is the surface area of a sphere of a given mass M, such that

r′=√(A/4π)−r=GM/3c² (34)

Furthermore, although equation 45, gives the same solutions as Einstein's equation, which is essentially correct, the difference is that the equation is now dependant upon Planck's constant (h), and moreover the radius of quintessence, which now defines a quantised solution to the equations.

Graviton Force Characteristics

Similar to the photon, the previously derived equation (42) for the graviton [(φ=(π/c)] appears to also mathematically represent a helical ringlet of quintessence, but with a spin of 2. For the photon, taking the direction of motion as the x vector and its axis of spin also as the x vector, would account for the electromagnetic force and its attraction and repulsion characteristics. In the case of the gluon component (π/c^{1/2}), if the direction vector is x, then the axis of spin would be in the y vector, the same as quasi electrons, accounting for the particle binding characteristics of the gluon force. (see; Gluon structure and force characteristics. Appendix 2). In the case of the graviton, if the direction of motion was in the x vector, the graviton spin axis would be in the z vector thus, as will be demonstrated, accounting for the gravitational force.

The spin axis of the graviton can also be derived using the known characteristics of the electron. If an electron is travelling in the x direction, then its spin axis is determined by the by the sign of the ⱼy vector (up or down). This view is in agreement with conventional theory, which indicates that the electron spin is similar to a rotating planet orbiting the sun, (the electron even appears to have orbital precession). As the electron passes through the space-time lattice, this spin would generate the formation of gravitons. This would occur as a result of the ejection of the excess quintessence passing through the electron. As the electron spins, the ejection of these gravitons would occur at a tangent to the electron's direction of motion. The ejection of the gravitons would occur, similarly to the ejection of energy of a pulsar or quasar, through the equivalent of the north and south poles of the electron. Thus, propelling the graviton in the direction of the electrons y vector. The ejection of the graviton would re-orientate and impart a specific angular momentum to the gravitons which would thus end up spinning on its own z axis. If for instance the graviton is released from an up spin electron the graviton will be rotating clockwise and its leading edge will displace quintessence downwards. In turn this will provide an upwards force.

This picture accounts for Fleming's left hand rule, is logical and provides an explanation for the magnetic force around a wire. According, to the left hand rule if the direction of the current is in the x vector, the magnetic field is in the z vector, and the force is upwards, in the y vector, in accordance with the above model. Therefore, this particular spin axis and the structure of the graviton results in its force characteristics. As the graviton is very small compared to the electron and both have different rather rapid spin axis it is difficult for these to bind and interact. Nevertheless, because the graviton has a spin of 2, and as it spin axis is perpendicular to its direction of motion, in the z vector, it readily displaces space-time quintessence to produce gravity. Thus because the graviton is able to displace space-time, it is capable of escaping a black hole. How else could the effects of gravity be felt beyond a black hole?

Quantum Gravity and Electromagnetism

With the above electron model of graviton production (see pp. 32), the nature of magnetism can be understood from first principles, Furthermore, the presence of a space-time lattice links relativity, and the forces of gravity with the electromagnetic and other forces of Nature. Indeed, evidence for these links may first date back to the 1820's, when Andre Ampere first defined the Amp. The force of attraction between two parallel wires 1 metre apart each carrying 1 Amp in a vacuum was defined as none other than the permeability of free space (2×10⁻⁷ N per metre of conductor). Thus conventionally the magnetic field strength around a long straight wire is given as:

B=μ₀I/2πr

Where I is the current and μ₀ is the permeability of free space (4π×10⁻⁷ N A⁻²).

The attraction between two wires both carrying negative charge is, however, counterintuitive as negative charges should repel. A conventional explanation overcomes this by invoking the presence of a magnetic field which is created by the current by the production of virtual photons. Thus we appear to have an explanation for the effects of magnetism which involves virtual photons, however, these photons are not observed. More accurately, according to conventional special relativity the magnetic field is none other than the electric field viewed relativistically^{(ref 19)}.

A more satisfactory explanation, therefore, lies in the interaction between the electrons and the space time lattice. The moving electrons in the two wires interact with the lattice to produce gravitons; which are in phase when both streams of electrons are travelling in the same direction. The gravitonic waves interact constructively to disperse the space time lattice between the wires and induce an attractive force between the two wires, which produces in effect the permeability of free space. Thus this force results from the vibration of quintessence itself.

Conversly in two wires with current going in opposite directions the graviton waves are in anti-phase and would interact destructively between the wires. The gravitonic waves travelling radially outward from the wires would, however, disperse the lattice outside the two wires and produce apparent repulsion between the wires, which is exactly what is observed. These effects of electricity suggest that gravitons act as waves and that phase is important.

This effect is also seen with the north and south poles of ferromagnets. Nevertheless, with matter other than iron, cobalt or nickel, the graviton emission cannot be phased as the atoms are unable to align and magnets do not appear to exist with other materials.

In ordinary magnetic system the release of gravitons from the north pole would be exactly balanced by those released from the south pole of the magnet and hence there would be no nett force on the magnet until an external magnet or electrical current were applied.

Overall the magnitude of the forces in electrical systems where electrical conduction occurs are well defined by the permeability and permittivity of free space μ₀, and ε₀. Where v is the constant velocity of the charge and ε is the electric field produced by the charge.

B=[μₒ.ε₀]v.ε

These observations suggest that the forces of electricity which produce magnetism are indeed related to the permittivity and permeability of free space and that these quantities are exerted by an apparent vacuum. Thus the effects of magnetism could be explained by none other than the phased effects of gravitational waves on the space time lattice.

Electromagnetism is of further interest to quantum gravity, particularly if we combine the standard equations, B=μ₀I/2πr and B=[μₒ.ε₀]v.ε, substituting for B we have:

2πr=I/ε₀.v.ε (46)

Thus 2πr is proportional to the inverse of ε₀. Thus as space time is dispersed by gravitons the permittivity field will increase in the same way capacitance increases with separation of plates. Because of the inverse relationship between ε₀ and 2πr, as ε₀ increases the circumference of a circle and the apparent ratio of π is to r, will appear to diminish in accordance with general relativity. This not an actual diminution in the circumference of a circle but the effective reduction of the resistance to motion in a circular path in this field.

Incidentally, the above observations, also lead us directly to Shrödinger's formula for the average equilibrium distance (r) between an electron with charge (e) in orbit around a proton, which is conventionally given by:

r=n²4π\overline{h}²ε₀/me²

Where εₒ is again the permittivity of free space, m is the mass of the electron and n is an orbital integer, h is Planck's constant and e is the charge of the electron. Furthermore if e=[ε₀/3(4/3πc³)]^{1/2} (eq.3); then the equation at n=1, for the electron orbital radius elegantly simplifies to:

r=4h²c³/m

Hence the orbital radius of the electron is related to spin of the electron (h) and its mass (m).

Quantum Gravity and the Charge of the Electron

The equation for the charge of the electron (eq. 1) contains the term so (permittivity of free space) which according to these observations should vary in a gravitational field.

$$e = {[ \frac{ϵ o}{3 ( 4 / 3 π {c}^{3} )} ]}^{1 / 2} \qquad \text{(6a)}$$

If we combine the standard equations, B=[μ₀I/2πr and B=(μₒ.ε₀]v.ε, substituting for B we have:

2πr=I/ε₀.v.ε (46)

Thus 2πr is proportional to the inverse of ε₀. Thus as space time is dispersed by gravitons the permittivity field will increase in the same way capacitance increases with separation of plates. Because of the inverse relationship between ε₀ and 2πr, as ε₀ increases the circumferance of a circle and the apparent ratio of π to r, will appear to diminish in accordance with general relativity.

Thus ε₀ rises when space-time is dispersed by the gravitons that produce the gravitational field, This occurs in a similar way to the process by which capacitance increases with separation of plates in a capacitor.

Nevertheless, as c is a constant and as c=[μ₀.ε₀]^{-1/2}, then if εₒ rises then μ₀ falls. This is entirely consistent as μ₀, which represents the force that quintessence exerts, would be reduced if the quintessence space time lattice is dispersed.

Furthermore, as μ₀=4π×10⁻⁷ N A⁻²; then as μ₀ falls, then the appareent ration π to r, also falls in a gravitational field. This is largely the same as stating, as does general relativity, that the apparent radius r′, rises in a gravitational field. So this view is consistent with general relativity.

Nevertheless, to derive an exact value for the charge of the electron we must account for gravity in the above equation. We will take the specific example of the Earth's gravitational field in order to obtain the exact value for the electron. If in accordance with standard general relativity, the apparent increase in radius r′ is:

r′=GM/3c² (34)

Then given that the mass of the Earth is 5.9745×10²⁴ kg; then

r′=1.47864×10⁻³ m

thus

2πr′=9.29057×10⁻³

Which is the incremental factor by which ε₀ must increase in Earth's gravitational field. So to correct ε₀ to account for gravity, ε₀ must be divided by the incremental factor, 2πr′. Similarly as effectively π decreases in a gravitational field, to correct π to account for gravity it must be multiplied by this incrememtal factor. So the equation for an electron in a zero gravtational field is:

$$e = {( [ \frac{ϵ o}{3 ( 4 / 3 π {c}^{3} )} ] )}^{1 / 2} \div ( 1 + 2 π {r}^{′} ) = 1.6022 \times {10}^{- 19} C \qquad \text{(6b)}$$

This now gives the charge of the electron as measured in a zero gravitational field as 1.6022×10⁻¹⁹ C, which is the same as that measured on Earth. Notably these observations appear to suggest that the charge of the electron is the same irrespective of the gravitiational field.

Virtually unlimited degrees of accuracy for the charge of the electron and for the fine structure constant (α), may be achieved by taking into account 2nd and nth order gravitometric effects. Thus if we take into account the effect of gravity upon the radius of the Earth it is also important to take into account an effect a upon the instruments with which we measure quantities, this would be a second order gravitometric effect. Thus taking into account 2nd order effects (r″), we have a very small, but nevertheless relevant change, such that: r″=r′(1+2r′). Thus 2r″=9.3180486×10⁻³, and thus:

$$e = {( [ \frac{ϵ o}{3 ( 4 / 3 π {c}^{3} )} ] )}^{1 / 2} \div ( 1 + 2 π {r}^{″} ) = 1.6021765 \times {10}^{- 19} C \qquad \text{(6c)}$$

This agrees exactly to the nearest 7 decimal places with the maximum accuracy of the experimental value for the charge of the electron.^{(ref 15)} Furthermore by taking into account the nth order gravitometric effect, it is theoretically possible to predict accuracy for the charge of the electron to 3n decimal places. This mathematically accuracy confirms the structure of the electron from first principles and indeed the theoretical effects of gravity on the permittivity of free space (ε₀).

This returns us directly to the fine structure constant for the electron which is conventionally given by: α=e²/\overline{h}c.4πε₀. If e²=ε₀/3(4/3πc³), accordingly the quintessential equation for α is structurally given by: 2π/α=m_{q}[3Θ]² (where Θ=4/3πc³; see The Structure of the Electron and Matter), we must now take into account the effects of gravity, as above, thus:

α2π/m_{q}[3Θ]²÷(1+2πr″)²=0.007297353

Where the gravitational term for the increase in radius r″ allows the mathematical derivation of α, and the above equation is in agreement with the conventional experimental value for α=0.007297353 to the nearest 9 decimal places.^{(ref 15)}

Hence the term (1+2πr″)² is in accordance with these observations for the effect of gravity on electromagnetic forces. To a maximum accuracy governed by current knowledge of the mass of the Earth and the Gravitational constant and thus the term for the gravitational increase in radius r′. These observations can also be used to accurately predict the magnetic moment of the electron (see Quantum Gravity and the Electron Magnetic Moment).

Thus the presence of the fine structure constant can now be further understood, by deriving the constant from first principles; specifically from the actual dimensional conformation for the charge of the electron: e=[ε₀/3(4/3πc³)]^{1/2} (eq. 6).

Overall the fine structure constant α (allowing for the term r′ which is the general relativistic increase in the radius of the Earth due to gravitation) is given by none other than the formula for the mass of quintessence and from the structure of the electron, which can now be derived from first principles to seven decimal places or more.

Quantum Gravity and the Electron Magnetic Moment

The theoretical origin and nature of magnetism remains obscure in current electromagnetic theory. An explanation suggests these magnetic effects are produced by photons, although no photons have ever been observed. To get round this difficulty it is postulated by physics that magnetism results from “virtual” photons. However, Maxwell's equation for electromagnetism states that the photon has no nett magnetic effect.

δBₓ/δx+δB_{y}/δy+δB_{z}/δz=0

Thus magnetism could not, by the above standard equation, be derived from a photon real or virtual.

In addition observational data suggests that black holes have powerful magnetic fields and as in theory photons are unable to escape from black holes (except for small quantites in the form of Hawking radiation), it would be difficult to explain these magnetic fields on the basis of photon emission.

Einstein postulated that magnetism was merely due to special relativity ^{(ref 17)}. The postulate for the nature of magnetism in these current observations, states that the magnetic force results from relativity due to none other than the phased emission of gravitons (why postulate two invisible forces, magnetism and gravity, when one, the graviton, will do). This view as previously discussed (Quantum Gravity and Electromagnetism) is entirely compatible with standard relativity.^{(ref 19)} Thus with the graviton origin of magnetism, the equation for the magnetic moment of the electron should have an expression in terms of quintessence and in turn the gravitational force and in particular the graviton.

The standard term for the magnetic moment of the Bohr Magneton (SIB) is:

μB=eh/4πmₑ

In standard quantum mechanics the Bohr Magneton, μB, however, needs to be corrected to agree with experiment. The “correction factor” is termed “ε”; where ε=(α/2π)−0.328α²/π²)=0.001159641. Thus theory reveals μₑ, the magnetic moment of the electron where:

μₑ=(eh/4πmₑ)[1+(α/2π)−0.328α²/π²)]

The conventional derivation of the term ε above, is given from the fine structure constant, (α/2π) which is theoretically consistent. However, a rather arbitary mathematical correction term; 0.328α²/π² needs to be used in this standard equation. This appears ad hoc and needless to say, more accurate measurements show , the electron magnetic moment to the Bohr magneton ratio, 1+ε=1.001159652, which suggests the correction factor is indeed incorrect. Nevertheless, this correction factor is essential for “renormalisation” and thus for quantum mechanics to work.

Quantum gravity readily explains the discrepancy between the theoretical Bohr Magneton (μB) and the actual measured magnetic moment of the electron (μₑ). In accordance with the above chapter (Quantum Gravity and the Charge of the Electron)

Thus the significant mathematical discrepancies can be removed by accounting for the effects of quantum gravity.

Thus taking the charge of the electron (e), using the equation for the Bohr magneton and the effects of quantum gravity such that gravitational change in radius is r″. The magnetic moment of the electron is given by:

μₑ=(eh/4πmₑ)(1+[α/2π÷(1+r″)])

This gives an electron magnetic moment to Bohr magneton ratio of 1.00115968. Thus the mathematical term for the magnetic moment of the electron is given, avoiding the arbitary and dubious term 0.328α²/π² used in the standard equation, simply by accounting for quantum gravity.

It is now possible to unite the equations for gravity and magnetism by substituting the fundamental key equations of quantum gravity. Thus if: h=3m_{q}c² (eq 1b) and mₑ=m_{q}.n_{q} (eq. 2). Then we can express the magnetic moment of any particle with the charge of the electron, including the proton, in terms of the number of quintessences (n_{q}) in that particle.

μB=ec²/4/3πn_{q} (47)

Given that the postulated structure of the graviton is: (φ=π/c (eq. 42), then substituting we have

μB=3ec/4φn_{q} (48)

Showing that the equations for the magnetic moment are compatible with the gravitational equations given earlier. Principally, the quintessential equations now allow the determination of the magnetic moment of any charged object from the equation for the graviton and directly from the number of quintessences it contains. In conventional physics the magnetic moment of the electron requires a correction factor, (1+(α/2πc)−0.328α²/π²)), to derive the correct experimental value. These observations herein, indicate that the correction factor is more logically (1+r″), where r″ is the general relativistic increase in radius around a gravitational body. This suggests that magnetism is not only affected by gravity, but can, as shown as above, be derived using the quantum gravitational equations.

Quantum Gravity and Special Relativity

Ordinary matter passing through the lattice would produce gravitons which would interact with space-time as described by general relativity. The quantity of gravitons would be determined by the apparent mass and in turn these would apparently curve space time. The geometry of this “curvature” is elegantly described by general relativity using Riemann geometry, specifically using metric tensors. Intriguingly the metric tensor is not a single number, but at each point in space time it is required to consist of a collection of ten numbers, Consequently, ten dimensional space-time hypotheses, such as this or superstring theory, may automatically yield general relativity. (see quantum general relativity p. 36)

General relativity is indeed very elegant, nevertheless there was a logical step yet to answer. That is, how do gravitons shape space time? This can now be readily answerd by considering the interaction of a three dimensional space time lattice with gravitons themselves to produce the effects of gravity. The effects of gravity are as such to compel a body in motion towards the gravitational object and to a much smaller extent visa versa. This effect can only be produced If gravitons repel quintessence (the constituents of the 3D lattice). Indeed, it has been stated that in order to explain cosmic inflation and the “flatness” of the Universe that quintessence must shun (or be shunned by) matter ^{(ref 5,6,7)}.

In descriptive terms a body close to a large mass will have a tendency to move toward it because the three dimensional lattice would be less dense as it approached the surface of the large mass. Overall there would be less resistance to motion in the direction of the large mass, and the motion in this direction would be facilitated by the vibration of quintessence.

In general relativity the principle governing motion is the geodesic of least distance, this can be re-expressed using similar equations using least action. Furthermore, the concept of motion due to the vibrations of quintessence is more logically and experimentally compelling.

These observations can now be used to link general and special relativity. Thus as we approach the speed of light, the mass of an object travelling through the space-time lattice would approach infinity, directly because the number of quintessences passing through a body would increase with increasing velocity, hence the equation:

m′=m₀/(1−v²/c²)^{1/2} (50)

or

m′=m₀/(1−v²[μ₀.ε₀])^{1/2} (50a)

In turn this would generate increasing gravitons and accordingly this would explain the observed effects of special relativity. Time itself is due to passage through the space-time lattice, and where the space-time lattice is dispersed by gravitons, time and length are reduced with increasing velocity and hence increasing space-time lattice dispersion, similar to the way in which gravity alters space-time

As a result:

t′=t(1−v²/c²)^{1/2}, l′=l(1−v²/c²)^{1/2}

Thus resulting in the effects of special relativity.

Quintessence and Black Holes

To address the relationship of the space-time lattice to gravity directly, it is important to discuss the concept of quintessence with regard to general relativitivistic equations. The standard general relativistic equation for the apparent increase in radius (r) due to the curvature of space time around a gravitational object, which has also been previously derived from first principles (eq. 36), is:

r′=G.M/3c² (34)

This can also thus be written as:

3r′=G.M[μ₀.ε₀] (51)

This standard equation, is in keeping with the above observations. Specifically, as the mass increases, ε₀ increases, in turn the radius will appear to increase (relative to π).

The above observations now allow us to examine the effects with regard to the interior of black holes themselves. The event horizon would represent a critical density for quintessence, in which light could not escape. The Schwarzschild radius would now be given by:

Rₛ=2GM[μ₀.ε₀]

The event horizon will occur at the point at which there is less resistance to circular motion than motion in a straight or partially curved line. Given that π is proportional to 1/ε₀. The event horizon should occur when the permittivity has increased by a factor of π.

Effectively because the permittivity of free space rises, π decreases. This is entirely in keeping with general relativity which predicts the effective change in the ratio of the radius to the circumference as given by the conventional equation, where r′, is again the apparent change in radius.

r=G.M/3c²

Hence π will effectively decrease as we approach the event horizon of a black hole, When π decreases to 1, the circular circumference is equal to the diameter and moreover, inside this limit it is shorter for light to travel in a circle. Thus light cannot escape the event horizon.

This can give us great insights into the workings of space-time, for flat Euclidean space the standard equation is:

e^{iπ}=−1

In accordance with general relativity, the ratio of the radius to the circumference changes in a gravitational field, and effectively π=1, at the event horizon, thus the boundary condition for the shape of space-time at the event horizon now has the direct equation:

e^{f}

Within a black hole as the permittivity of space increases by a factor of 2π an object within it will complete two rotations rather than travel in a straight line. In effect exceeding the speed of light by 2π. Hence, the condition for space-time is represented by the equation:

e^{i/2}

Thus an increase in the permittivity of free space by a minimum factor of π, to produce a black hole is estimated to result from an increase in mass by a factor of approx. 10⁶ (the ratio of the mass of the earth and that of a putative black hole).

Continuing with the subject of a black hole, according to the model inside the black hole, the gravitons produced by the matter present would be in equilibrium with the density of the space-time lattice. Increasing the rate of rotation of the matter in the black hole for instance would thus increase the production of gravitons and its effective mass and increase the radius of the event horizon. A density gradient of the space-time lattice would continue to exist within the black hole. Progressively closer to the centre of a black hole matter itself would be increasingly compressed and the spherical structure of the quasi electron would be predicted to collapse. This collapse would result in the formation of an exotic form of matter in the form of pure quintessence in a black hole.

This pure quintessence would produce the singularity at the centre of the black hole. The larger the black hole in terms of mass the more pure quintessence would exist at its core.

Quintessence and the Big Bang

Quintessence theory not only predicts the occurrence of the Big Bang, but allows a prediction for the value of the entire mass of the Universe, from first principles.

In accordance with quintessence theory the big bang resulted from the explosion of an immense black hole singularity, which was constituted from pure quintessence.

On the basis of quintessence, there will be a critical mass for Big Bang event; thus if entire space-time between quintessence is compacted so that no further quintessence can be accommodated, the addition of further quintessence would destabilise the immense black hole, resulting in the Big Bang.

It is possible to predict this critical mass, using the radius of quintessence as a benchmark. Given the nine spatial parameters present in the metric tensor, used in general relativity we find that the actual formula for the radius of quintessence; r_{q}², is mathematically in agreement with general relativistic theory when:

9r_{q}²=Gh/C³ (33)

This again supports the 9 dimensional view of space (so crucial in superstring theory). Moreover, the size of the vibrations of quintessence can thus be calculated as:

r_{q}=1.35×10⁻³⁵m (33a)

The volume of each quintessence is thus:

4/3πr_{q}³=1.0306×10⁻¹⁰⁴ m³ (33b)

So to be accommodated within unit volume of space time, with no intervening apparent space time, (given that each of 9 overlapping quintessences are required) would require approx.

9×10¹⁰⁴ quintessences

As the mass of quintessence is m_{q}=h/c²=7.373×10⁻⁵¹ kg.sec (eq. 1). Then the mass of of the Universe, to two decimal places, is:

1.18×10⁵³ kg (33c)

This is in close agreement with a recent estimate of the mass of the Universe from COBE and other satellite data, which estimates the mass to be 100 trillion trillion trillion trillion tonnes (10⁵³ kg). ^{(ref 20)}

Moreover, the early formation of the galaxies can be readily explained, it is likely that in such a big bang some very small black holes might have prevailed and that these formed the seeds of the galaxies we see today.

The event horizon, calculated from the Schwartzschild radius, of such an immense black hole is ˜10²⁶ m, which would have allowed Guth's inflationary component to the early expansion of the Universe.

In addition, inflation may result directly from the observation that once electrons have formed from the primordial soup of quintessence, they emit gravitons which in turn repel space time, which might also result in another cosmic inflationary cycle.

Most importantly quintessence theory explains the Big Bang from first principles and and is capable of accurately predicting the mass of the Universe.

The Nature of Energy

Foremostly, these observations allow a fundamental understanding of energy. The quantum physical, minimum component of energy is Planck's constant; h. To define the minimal component of mass, using the standard energy equivalence formula; E=mc², such a minimal mass (m_{q}) would be required to have the value equivalent to; m_{q}=h/c² (1). The total mass of a system (m) would then be; m=m_{q}n_{q}, where n_{q} is the number of these minimal units. Thence, the total energy of a system can be derived from the minimal energy; h, multiplied by the number of these energy units (n_{q}). Thus as, E=mc², then also E=m_{q}n_{q}c² and substituting m_{q}=h/c², the energy equivalence formula has the more logical formulation;

E=hn_{q} (1a)

Thus the energy of a system is equivalent to the minimal energy unit; h, multiplied by the number of those minimal energy units (n_{q}).

This leads directly to a deeper understanding of wave particle duality and the wave nature of matter.

This is encapsulated by the quintessential energy formulae

As conventionally βE/c=p, then

λ=h/p=hc/βE (2)

and

E=hn_{q} (1a)

then

λ=c/βn_{q} (2b)

Importantly, as indicated by equation (2b), energy having no quintessence; would have a wavelength of infinity. Specifically pure energy containing no quintessences, would have a lambda of infinity. According to quantum mechanics an infinite wavelength would result in the probability of that energy being anywhere. As energy itself has no electrical charge it would not be impeded by the permittivity and permeability of the three dimensional space-time lattice. Moreover, energy would not be detectable in three dimensional space-time, unless it interacted with matter, as in the EPR experiments. Indeed, energy is not observed when not bound to any form of mass or particle.

Thus equation 2b, takes us to our original assertion regarding the existence of pure energy.

### -Energy is not bound by the space-time lattice-

Thus, as the EPR experiments suggest the existence of energy separate from matter and thus separate from the three dimensional space-time lattice, it is interesting to find that experiment suggests the existence of free energy in a continuum separate from space time and matter to produce the effects of quantum teleportation.^{(refs 10, 11, 12, 13)}

This is not, however, teleportation across an additional dimension, this is a term to describe in partially familiar terms the dissociation of energy from the three dimensional space-time lattice. As time is inextricably linked to each dimension of space, the effects of energy would be inextricably linked to the events, such as the creation of virtual particles, we see interacting within space-time. It is unlikely that observers have any direct day to day experience to explain quantum events. Nevertheless, quintessence theory may have given us a window into the hitherto hidden workings of the Universe. Thereby, the mystery of the uniformity of the Universe, across distances which the speed of light could not apparently traverse, is readily explained by the fact that the free energy contained in the Universe is not bound by the space-time lattice.

In the case of light, due to the exceedingly small masses involved, there would be relatively easy exchange of matter with free energy within a photon. This would make the photon the ideal experimental tool to look for energy which is not bound by matter and in turn energy which is not bound in space-time. Indeed, very recently Furusawa et al. have reported to have observed the transference of energy as photons from A to B, without those photons traversing space-time^{(ref 10)}. This finding which has been supported using other experimental techniques^{(refs 11, 12, 13,)}, is very important as it suggests the existence of such free energy.

Overall, quintessence theory gives an a priori explanation for the concept of mass, the elementary particles, the forces of nature and quantum effects. It can equally be used logically to explain the inner physics of a black hole, the missing mass in the Galaxy, the expansion of the Universe, Guth's inflationary theory and predicts the Big Bang, from first principles.

### Prior Art

Antigravity Systems

Recent research at NASA indicates that an antigravity device may be feasible. This research, however, has been undertaken at NASA without fundamental knowledge of the theoretical basis of quantum gravity. In these experiments the use of radio frequency (RF) pulses, such as in Nuclear Magnetic resonance, on rotating superconducting discs has been attempted, to produce antigravity effects.^{(ref 21)}

However, radio frequency pulses are a weak form of electromagnetic radiation and are therefore unlikely to provide sufficient energy to produce measurable antigravity effects.

The warp drive technology described in this application is entirely different to previous prior art. The most important difference relates to the nature of the invention. In this application specifications are given for a direct drive system, as opposed to a gravity shield device, which other inventions claim. There is of course a vast difference as a shield device, merely reduces the force of gravity, but does not directly produce drive.

The references specifically relating to the shield effect are:

| | | |
|---|---|---|
| SCHNURER: | WO 98/23976 | 14 Nov. 1996 |
| MODANESE + | arXiv:gr-qc/9612022 v4, | 19 Feb. 1998 |
| SCHNURER: | | |
| PODKLETNOV: | arXiv:cond-mat/9701174 v3, | 16 Sep. 1997 |
| PODKLETNOV + | Physica C, Vol 203, 441-444, | 9 Sep. 1992 |
| NIEMINEN: | | |

Other devices produce an attractive effect, as in an electromagnet magnet, which is again entirely different to the direct production of drive.

HOOPER U.S. Pat. No. 3,610,971 Apr. 15, 1969

In these and other antigravity devices the use of equal and opposite currents in a superconductor to produce anti-gravity effects are disclosed, as in:

BETTELS DE19832001 Jul. 16, 1988

In this application for Warp Drive technology, there is a differential current applied. Thus the differential speed of the electrons will, in accordance with relativity, produce differential mass, which will in turn result in a differential graviton release. Thus this invention is very different to previous disclosed inventions, as it is the differential graviton release, which produces the effective warping of space-time, to produce a direct warp drive system, which operates by the warping of space-time.

### SUMMARY OF THE INVENTION

Principles of Warp Drive Systems

The theoretical understanding of quantum gravity allows the design of warp drive systems from first principles. It is unlikely that gravitons can be controlled in a precise way using current technology. Nevertheless, an understanding of three dimensional space-time and matter, does allow the design of elementary warp drive systems. That is, systems whose propulsion rely on warping space-time as opposed to the ejection of material to provide thrust.

The background for these systems are already partially understood and quintessence theory allows their further development. For instance, the formation of black holes, represents a crucial step in understanding the mechanisms that underlay gravitational physics and in turn the warping of space-time. The existence of black holes, implies that the warping of space-time allows a powerful system for driving matter. In this instance the space-time lattice would be repelled by gravitons in such a way as to disperse space-time quintessence in a circular fashion, producing an event horizon. Similarly if we suppose that gravitons could be controlled and collimated in a single direction similar to a laser using photons, it would be possible to focus such a graviton beam ahead of an object. This in turn would dissipate the space-time lattice in front of that object, thereby allowing the theoretical potential for what is termed Warp drive.

Essentially, these are systems whose propulsion relies on warping space-time, as opposed to the ejection of material to provide thrust. This does not, of necessity, mean that superluminal velocities are produced, but that the drive is based on the warping of space-time in accordance with general relativity. However, it would in the future theoretically be possible for an object to achieve speeds greater than that of light, as superluminal velocities produced by the warping of space-time do not contravene general relativity.

Indeed according to the standard model, if the horizon distance is taken as the maximum distance which light could have travelled, then two points on opposite sides of the Universe are as far apart as ninety times the horizon distance, which indicates that components of the Universe themselves have effectively far exceeded the speed of light. ^{(ref 20a)}

With current technology warp drive systems (not of necessity superluminal) could be achieved by rotating intermediate sized superconducting masses at ultracentrifugational velocities. The release of gravitons could be controlled by differentially governing the electron flow through these masses with the use of powerful electric currents. In turn the differential direction of flow of gravitons would determine the direction of motion through the space time lattice.

In order to design a mechanism for elementary warp drive we may utilise either a normal conductive material or preferably a superconducting material, or a combination of both. It may be possible to use any shape, such as a disc, cylinder or preferably a sphere. It would also be possible to use dual counter rotating discs to minimize the net angular momentum of the system. In the case of a sphere, this is rotated along its horizontal axis in a clockwise fashion at ultracentrifugational speeds. A differential current is then applied from left to right in such a way as to pass through the entire sphere in this direction.

The electric charge in the upper half of the sphere would be maximised. The electrons will have a vector in the left to right direction as the sphere spins clockwise. If a maximised current is applied to the sphere in the same direction this will result in a increase in the velocity of the electrons relative to the centre of gravity of the rotating object, due to the flow of current. In turn, according special relativity and to the space-time lattice model, this wilt result in an increase in the relativistic mass if the electrons and in turn by general relativity an increase in the release of gravitons.

Conversley in the lower half of the sphere the electrons wilt have a vector of motion in the right to left direction due to the spin of the sphere. This will be relativistically slowed by the differential current applied in the same direction as the current above, and hence in the opposite direction to the direction of rotation. The charge can be separately applied and adjusted to ensure that the electrons are relativistically stationary relative to the centre of gravity. In turn this will minimize the relativistic mass and result in a decrease in the release of gravitons for the lower half of the sphere.

The overall result will be a greater release of gravitons in the upward direction and a lesser release of gravitons in the downward direction. The effect will be enhanced by the use of a multi-phasic current simultaneously applied. This will result in the release of multi-phasic gravitons which will disperse space time above the sphere with increase in density below the sphere which will effectively reverse the effects of Earths gravity. Importantly this effect can also be produced with the use radio frequency pulses. This obviates the need for commutator devices. Nevertheless, the radio frequency pulses must be designed to produce a change in the spin of the particle to enhance the release of gravitons in the upward direction, and moreover with current technology theses RF pulses contain too little energy to effect a significant change in the gravitational field.

With the use of large currents the drift velocity of the electrons could be greatly increased. The use of superconducting devices would greatly enhance the efficiency of such systems as the electrical resistance is virtually eliminated. Thereby allowing large currents to be used with minimum total power output.

The technological crux of the device is to produce electrons of high speed and hence high relativistic mass in the top half of the sphere, whilst producing low speed and thus low mass electrons at the bottom of the sphere, in accordance with special relativity. The imbalance in the rotating sphere will be continuously present impelling the device upwards. In effect the differential current flow, will produce differential graviton production and in turn, by general relativity, the warping of space-time

### TECHNICAL EXAMPLE 1

A small scale device, which produces warp thrust can be readily constructed using current technology.

This wilt require a sphere, cylinder or disc of superconducting material. A dual disc either co rotating or counter rotating could also be used, counter rotating discs have the advantage that the total angular momentum is effectively zero. Any of the superconductors may be used such as Ag₂F, C₈K or SnTe. However for their tensile strength and/or magnitude of critical current density (J_{c}), Nb₃Sn or Ag₂F is recommended. Normal conductive material may be used but due to electrical resistance the power required (see superconductivity theory pg. 9) would be in the order of 10¹⁹ times greater.

Taking a sphere of Nb₃Sn, made hollow to reduce the mass of the sphere, with an external radius 0.25 m and an internal radius of 0.20 m; the total volume of Nb₃Sn required would be 3.19×10⁴ cm³. As Nb₃Sn has a density of 7.86 g/cm³ the total mass of superconducting material would hence be 250 kg.

This sphere is required to be mounted upon two ultracentrifugational spindles which themselves are on the horizontal axis. The untracentrifugational spindles would be powered to rotate the sphere to produce an enhanced g force, as in a centrifuge.

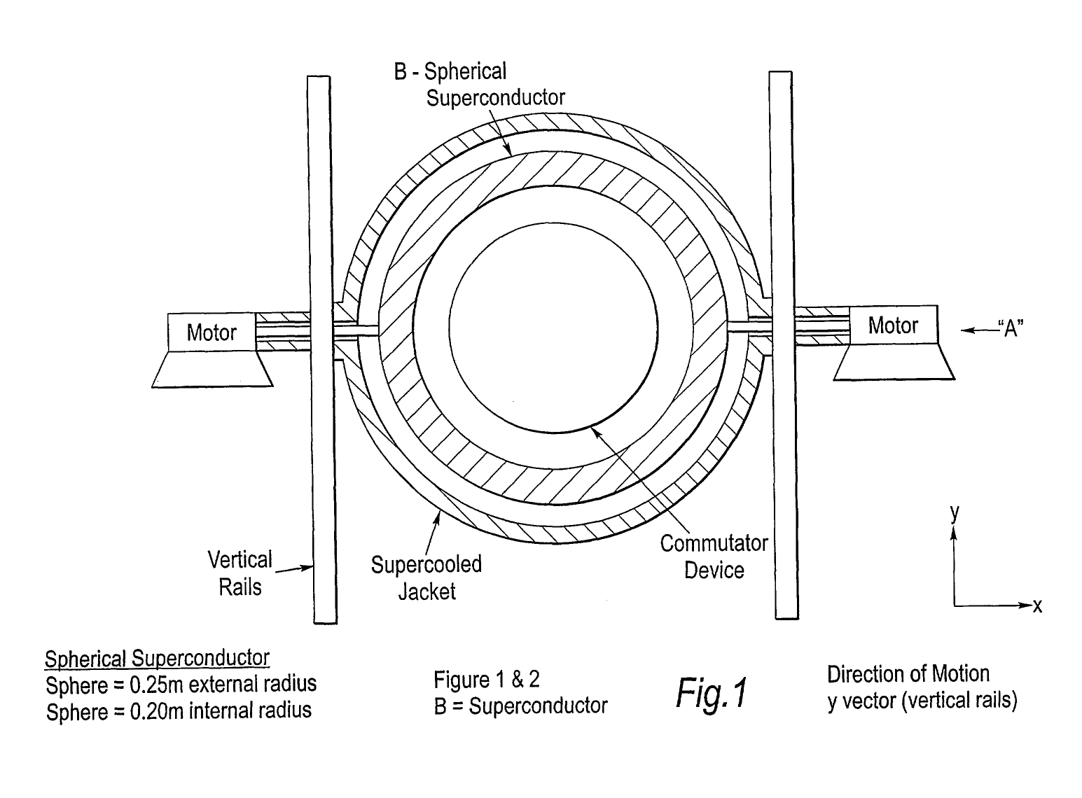

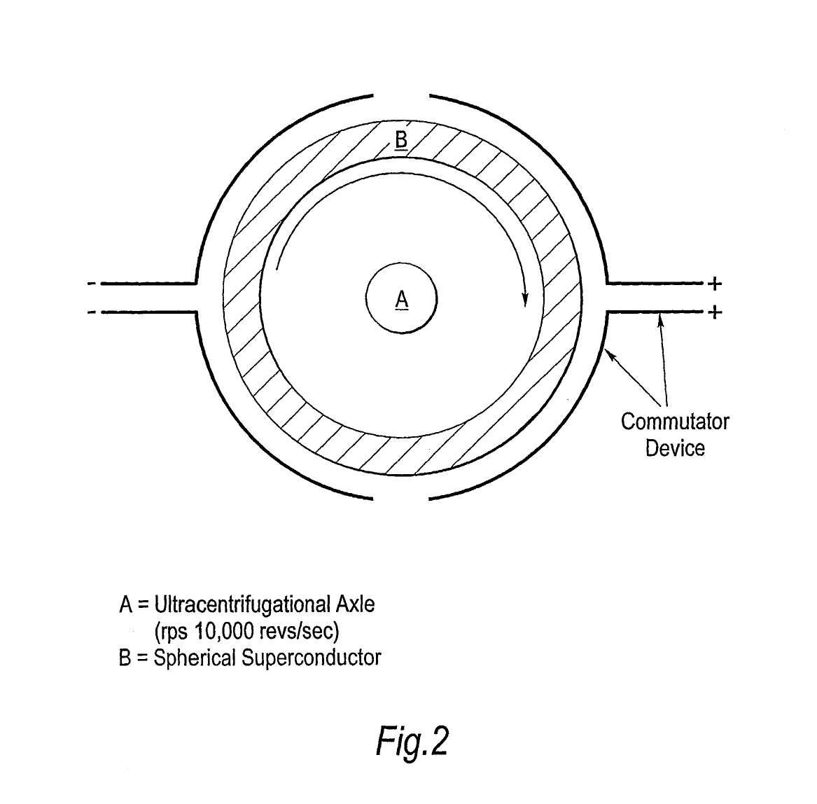

The superconductive sphere would require a supercooloed jacket of liquid Helium, and would require to be in a vacuum. The power source, motors and refrigeration system should be placed outside the supercooled jacket. In addition these ancillary elements of the device may be either placed outside the system as a whole, or within it, if the device is designed as a self contained vehicle. The device may also be mounted upon vertical rails to experimentally demonstrate vertical lift. (See FIGS. 1, 2)

A high current needs to be applied, by means of a commutator device, to produce a current passing through the sphere. If the negative terminal were placed on the left of the sphere and the positive terminal on the right this would produce electrons flowing from left to right. The commutator device would be split to allow a smaller current to be applied to the lower half of the sphere.

The power expenditure for this is reduced by using a superconducting material. If the sphere were rotating from left to right i.e clockwise the drift velocity of the electrons would be advanced in the upper half of the sphere, and retarded in the lower half of the sphere by the differential current induced flow of the electrons.

According to relativity, as defined in the theoretical sections above, it is accepted that the mass of the electrons in the upper half, relative to the centre of gravity, of the sphere can thus be increased by using the standard relativistic formula:

m′=m₀/(1−v²/c²)^{1/2} (50)

Thus by inducing a relative drift velocity difference, the mass of the electrons at the top of the sphere can be increased, and the mass of the electrons at the bottom of the sphere can be reduced relative to the centre of gravity.

If the object is set to rotate, centrifugal forces can be used to increase this mass difference. This can be used to increase the net momentum of the object in the upwards direction, to produce upwards thrust.

Given that there are approximately 10²³ per cm³ free electrons in a niobium conductor then in the total sphere there will be approx. 10²³×3.19×10⁴ cm³=3.19×10²⁷ free electrons in the sphere. If each electron weighs 9.11×10⁻³¹ kg; then the total mass of free electrons in the upper half of the sphere is 1.453 grams.

If we take the maximum zero voltage current density (J_{c}) in Nb₃Sn or another suitable superconducting device as approximately 10×10¹⁴ Amps/m², the drift velocity in the electrons can be calculated. Given that the average surface area of the hollow sphere is approximately 350 cm² or 3.5×10⁻² m², then the max current applicable is 3.5×10¹³ Amps. Thus the drift velocity of the electrons would be 6.3×10⁶ m/sec. The velocity of the electrons in the upper part of the sphere would be advanced relative to the centre of gravity. The relative velocity to this centre would be equivalent to the velocity of the sphere plus the velocity of the electrons in the upper half.

If the drift velocity of the electrons in the lower half were separately, induced by the current so that these electrons were stationary relative to the centre of gravity, those in the lower half of the sphere would be relatively retarded. The current applied to the lower half of the sphere to make the lower electrons, relative to the centre of gravity, stationary (given a rotation rate of 3.14×10⁴ revs/sec) would be 2.46×10¹¹ Amps.

This differential current would allow the electrons to have a differential velocity and in turn a different mass relative to the centre of gravity. The relative velocity would be approximately 6.3×10⁶ m/sec. Using the standard equation for relativity (50) would give a relative mass difference ratio of 2.21×10⁻⁴.

The effective total mass difference between the upper and lower half of the sphere would thus be the mass of the electrons times the relative mass difference which is 1.45 grammes×2.21×10⁻⁴=3.2×10⁻⁷ kg.

Overall, as the acceleration due to gravity is 9.81 m/sec²; to produce upwards lift on a sphere of 250 kg in Earth's gravitational field would require a force of about 2,500N. In order to produce in excess of this force the acceleration produced by the ultracentrifuge device would need to be about=8.76×10⁹ m/sec². Thus according to the formula a=(ω2πr)²/r (where the average radius, r of the device is 0.225 m) the rotation rate required would be 3.142×10⁴ revs/sec or approximately 1,880,000 revs/min to produce sufficient acceleration to allow the device to completely self levitate. Thus as F=ma, then the force produced by the device is

3.2×10⁻⁷ kg×8.76×10⁹ m/sec²=2,800 N

A detectable anti-gravtiy effect could, however, be realised at much lower spin rates. Standard ultracentrifugation devices can rotate at 600,000 revs/min. Thus even at standard ultracentrifuge speeds the g forces produced would be sufficient to produce approximately 12.8% lift, using these anti-gravity techniques.

### TECHNICAL EXAMPLE 2

For this example we will use a large scale device, which would therefore deliver sufficient thrust to power a vehicle beyond Earth's gravitational field. Under terrestrial conditions the entire devise would be required to be encased in a liquid helium jacket, with an internal vacuum to reduce friction due to air. However, the tatter two constraints need not be in place if the device is to be used in space as, very conveniently, space is both a vacuum, and when shielded from the rays of the sun the ambient temperature is less than that of liquid helium. Indeed the large mass of the superconductor becomes less relevant as weightlessness exists in space, so that the size of the object may be increased substantially.

Taking a sphere of 1 meter in radius of a superconductive material. The volume is 4/3πr³=4.2×10⁶ cm³. If the high temperature superconductors are used such as YBa₂Cu₃O₇, or Nd_{1.85}Ce_{0.15}CuO₄, which are ceramic in nature, the specific density is approximately 3 g/cm³, Hence the total mass of the sphere would be approximately 12,600 kg or 12.6 metric tonnes. If the standard superconductors are used, for instance Nb₃Sn with a density of 7.86 g/cm³ the sphere becomes heavier at 33 metric tonnes

This sphere is required to be mounted upon two ultracentrifugational spindles which themselves are on the horizontal axis. The untracentrifugational spindles would be powered to rotate the sphere to produce an enhanced g force, as in a centrifuge. The sphere would need to be carefully constructed to be exactly balanced in all directions.

Nevertheless, a high current does still need to be applied, by means of a commutator device, to produce a current. If the negative terminal were placed on the left of the sphere and the positive terminal on the right this would produce electrons flowing from left to right. The power expenditure for this is reduced by using a superconducting material. If the sphere were rotating from left to right i.e clockwise the drift velocity of the electrons would be advanced in the upper half of the sphere, and retarded in the lower half of the sphere by the current induced flow of the electrons. The split commutator device allows a differential current to be applied to the upper and lower halves of the sphere respectively.

According to the model in the preceding sections this will result in an increase in the mass of the electrons in the upper sphere and hence an increase in graviton production in the upper half of the sphere. Indeed, this model is in agreement mathematically with general and special relativity.

Given that there are approximately 10²³ per cm³ free electrons in a copper conductor then in the total sphere there will be approx. 10²³×4.2×10⁶=4.2×10²⁹ free electrons in the sphere. If each electron weighs 9.11×10⁻³¹ kg; then the total mass of free electrons in the upper part of the sphere is 0.191 kg.

If we take the maximum zero voltage current density (J_{c}) in Nb₃Sn, or another suitable superconducting device, as approximately 10×10¹⁴ Amps/m², the drift velocity in the electrons can be calculated. Given that the average surface area of the sphere is approximately 1.57×m², then the max current applicable is 1.57×10¹⁵ Amps. Thus the drift velocity of the electrons would be 6.3×10⁶ m/sec.

At the same time the current in the lower half of the sphere would be adjusted to retard the electrons so that they remain stationary relative to the centre of gravity. If the sphere were rotating at 2.6×10⁴ revs/sec this would require a current of 2.04×10¹³ Amps. This differential current would induce a differential velocity in the electrons and in turn a mass difference.

By inducing a difference of mass as little as one part in a thousand in these electrons we can achieve significant lift. Thus by the above equation if we induce a drift velocity of 6.3×10⁶ m/sec (as in technical example 1), given that the velocity of the electrons in the upper part of the sphere would be advanced relative to the centre of gravity and those in the lower half of the sphere relatively stationary; then the relative velocity would be approximately 6.3×10⁶ m/sec. Thus between the upper and lower half of the electrons we increase the relative mass of the electrons in the upper half by a factor of 2.21×10⁻⁴, as in technical example 1.

Thus the difference in mass in the upper half of the sphere due to the moving electrons would be 0.191 kg×2.21×10⁻⁴=4.22×10⁻⁵ kg., relative to the lower half electrons. This difference is enhanced by producing a centrifugal force by rotating the sphere.

If we rotate the large superconducting sphere at 2.6×10⁴ revs/sec or 1,560,000 revs/min we can achieve accelerations of 1.33×10¹⁰ m/sec² (given an average radius of 0.5 m) by the formula a=(ω2πr)²/r.

Thus as F=ma, where m is the relative mass difference of the electrons the thrust produced in the device would be equivalent to:

4.22×10⁻⁵ kg×1.33×10¹⁰ m/sec²=5.88×10⁵ N

Thus in Earth's gravitational field this force would be capable of levitating 60 metric tonnes.

The estimated current required to produce the drift velocity of the electrons for this effect would be approx. 1.57×10¹⁵ Amps. The power usage is given by; P=I²R, under non-superconducting conditions, given that Niobium has a resistivity of 15.2×10⁻⁸ Ω/m the sphere would have a resistance of approximately 10⁻⁷ Ω. The power used by a non-superconducting device would thus be 2.46×10²³ Watts. However, due to superconductivity, under standard theory, the device has zero resistance and would use no power^{(ref 8)}. Nevertheless, if we wish to use the model described above for superconductivity (see superconductivity, page 6) there would be a practical power consumption which would nevertheless still be low. Thus the power consumption would be in the order of 1.6×10⁻¹⁹ less than the standard power usage, at 3.94×10⁴ Watts.

If Nb₃Sn is used to make the sphere the mass of the sphere would be 33 metric tonnes. If the mass of the ancillary ship were 27 metric tonnes, giving a total of 60 metric tonnes the acceleration produced would be 9.81 m/sec² . This would be equivalent to the force of gravity on Earth. Thus an artificial gravitational field would be incidentally created which would be exactly equivalent to that on Earth. Thus the device could also be used for the production of artificial gravity.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

### REFERENCES

1. Mesoscopic behaviour of the neutral Fermi gas ³He confined in quantum wires. S. L. Phillipson, A. M. Genault, S. N Fisher, G. R. Pickett, P. J. Y Thibault. Nature, 395: 578-580.

2. Direct Observation of d-orbital Holes and Cu-Cu Bonding in Cu₂. J. M. Zuo et al. Nature 401: 49-52.

3. The Foundation of the General Theory of Relativity, A Einstein. Translated from “Die Grundlage der Allgemeinen Relativitätstheorie”. Annalen der Physik, 49, 1916. Published in, Einstein, The Principle of Relativity, Dover publications, 1952.

4. Sidelights on Relativity. Ether and the Theory of Relativity Albert Einstein. Dover Publications 1983.

5. Inflation is dead long live inflation. George Musser. Scientific American, July 1998, p 9.

6. The flip side of the Universe. George Musser. Scientific American, September 1998, p 13.

7. The Fifth Element, Marcus Chown. New Scientist, Apr. 3, 1999, pp 29-32

8. The Quantum Universe. Tony Hey and Patrick Walters. Cambridge University Press 1987. (Solving the Shrödinger equation pp. 165-167).

9. Complex Numbers, Mathematics for Engineers. W. Bolton; Longman Scientific & Technical; Chap. Introducing Complex Numbers, p 1-11.

10. Unconditional Quantum Teleportation. A. Furusawa, I. Sorensen, S. L. Braunstein, C. A. Fuchs, H. J Kimble, E. S. Polzik. Science, Oct. 23, 1998. Vol. 282: 706-709.

11. Complete quantum teleportation using nuclear magnetic resonance. M. A. Neilsen, E. Knill, R. Laflamme. Nature, Nov. 5, 1998. Vol. 396: 52-55.

12. Experimental quantum teleportation. D. Bouwmeester et al. Nature, 390: 575-579 (1997).

### REFERENCES (cont.)

13. Experimental realization of teleporting an unknown pure quantum state via dual classical and Einstein-Podolski-Rosen channels. D. Boschi, S. Branca, F. De Martini, L. Hardy, S. Popescu. Phys. Rev. Lett. 80: 1121-1125 (1998).

14. W. Tittel, J. Brendel, H. Zhuniden, N. Gisin, Phys. Rev. Lett. 81: 3563-3566. (1998)

15. Into the Vortex. Charles Seife. New Scientist, Oct. 24, 1998. p 7.

16. Direct observation of a fractional charge. R de Picciotto, M Reznikov, M. Heibium, V Umansky, G. Bunin, D. Mahalu. Nature, 389: 162-164.

17. Tables of Physical and Chemical Constants. Kay & Laby. Longman Scientific & Technical.

18. Physics in Focus. Michael Brimicombe. Section, Wave Mechanics; p 521. Nelson

19. Special Relativity. A. P. French. Nelson. Chapter 8, Special Relativity and Electricty, pp 256.

20. Universe In Balance. Jeff Peterson. New Scientist, 168: p 27

20a. The Accelerating Universe. Mario Livio. John Wiley and Sons, Inc. (2000)

21. Escape from Earth, Charles Seife, New Scientist, Feb. 6, 1999. p 6.

22. The Discovery of the Top Quark. Tony Liss and Paul Tipton. Scientific American; September 1997, pp. 26-41.

23. The Mystery of the Nucleon Spin. Klaus Rith and Andreas Schaifer. Scientific American: July 1999, pp 42-47.

24. And you're glue. Frank Wilczek. Nature; 400, pp 21-23.

1. A method of generating a force on a body, wherein a differential electron flow through the body in rotation is directed so as to simultaneously pass through said body in its direction of rotation and contrary to its direction of rotation to release a directed flow of gravitons.

2. A method of accelerating a body by generating a force acting upon it by the method of claim 1.

3. A method according to claim 1 or 2, wherein electrical currents are passed simultaneously through said body in its direction of rotation and contrary to its direction of rotation.

4. A method according to any one of claims 1 to 3, wherein the body is a least partly of superconducting material.

5. A device for generating a force sufficient to accelerate a body, the device comprising;
the body in the form of an electrically conducting mass, means for rotating said mass and means for passing electrical currents simultaneously through said mass in its direction of rotation and contrary to its direction of rotation.

6. A device according to claim 5, wherein the mass is spherical, cylindrical or consists of a dual co-rotating or counter rotating disc.

7. A device according to claim 5, wherein the mass is cylindrical.

8. A device according to claim 5, wherein the mass consists of a disc.

9. A device according to claim 5, wherein the mass consists of dual co-rotating or counter rotating discs.
